(19) United States
(12) Patent Application Publication
(10) Pub. No.: US 2017/0052396 A1
(43) Pub. Date: Feb. 23, 2017

(54) LIQUID CRYSTAL DISPLAY PANEL AND METHOD OF LIQUID CRYSTAL ALIGNMENT THEREOF

(71) Applicant: AU Optronics Corp., Hsin-Chu (TW)

(72) Inventors: Wei-Cheng Cheng, Hsin-Chu (TW); Tien-Lun Ting, Hsin-Chu (TW); Wen-Hao Hsu, Hsin-Chu (TW); Chen-Chun Lin, Hsin-Chu (TW)

(21) Appl. No.: 15/227,951

(22) Filed: Aug. 3, 2016

(30) Foreign Application Priority Data
Aug. 21, 2015 (TW) 104127293

(51) Int. Cl. G02F 1/137; G02F 1/1335; G02F 1/1337; G02F 1/1362; G02F 1/1368; G02F 1/1333; G02F 1/1343

(52) U.S. Cl. CPC G02F 1/137; G02F 1/133345; G02F 1/133514; G02F 1/134309; G02F 1/13439; G02F 1/136286; G02F 1/1368; G02F 1/133711; G02F 2001/134345; G02F 2001/136222; G02F 2201/123

(57) ABSTRACT

A liquid crystal display panel includes a first substrate, a conductive line, an active switch device, a pixel electrode and a first electrode. The pixel electrode has a cruciform opening, which includes a first slit extending along a first direction and a second slit extending along a second direction intersecting the first slit. The first electrode is disposed on the first substrate and located adjacent to the periphery of the pixel electrode. The pixel electrode includes two first parts and a second part, where the two first parts are respectively disposed adjacent to two opposite ends of the second slit in the second direction. The distance between the two first parts in the second direction has a first width, the second part has a second width in the second direction, and the first width is greater than the second width.

### BACKGROUND OF THE INVENTION

1. Field of the Invention

The present invention relates to a liquid crystal display panel and a method of liquid crystal alignment thereof, and more particularly, to a liquid crystal display panel which has a high transmittance and related method of liquid crystal alignment.

2. Description of the Prior Art

Since the liquid crystal display panel has advantages of less volume and weight, and energy-efficiency, it is used extensively in every kind of electronic product, such as smart phones, notebook computers, tablet PCs and soon. Because of the effect of wide viewing angles, the Polymer-Stabilized Alignment (PSA) liquid crystal display panel is fabricated to be a high contrast and wide viewing angles display, such as a TV, a monitor, a notebook computer, and a public information display. The fabrication process of the PSA liquid crystal display panels is mixing a few photo-curing monomers in the liquid crystal molecules, providing voltages to generate a pretilt angle of the liquid crystal molecules, and utilizing the ultraviolet (UV) light adequately for exposing the photo-curing monomers and make the photo-curing monomers polymerize. Making a comparison with the Multi-domain Vertical Alignment (MVA) liquid crystal display panel, the MVA liquid crystal display panel further requires a structure like protrusion to assist alignment, and the PSA liquid crystal display panel can improve the dark-state light leakage. Because of the higher contrast and wider viewing angles, each pixel of liquid crystal display panel is divided into a plurality of alignment areas, and the pixel electrodes which include a plurality of branched pixel electrodes extending along different directions make the liquid crystal molecules in different alignment area lie down towards different directions when the pixel electrodes are provided the voltages. However, because the liquid crystal is a continuum, the intersections of branched pixel electrodes extending along different directions have many areas which the arrangement of the liquid crystal molecules is discontinuous and make the efficiency of the liquid crystal decrease. The microscopic observation is dark lines would appear in the pixel, and the macroscopic observation is the quality is decreased caused by the transmittance decreasing.

The disclosed prior art in the above is only for understanding of the background of the present invention. Therefore, it may include some parts that do not belong to any part of related conventional technology and do not give any inspiration to those skilled in the art.

### SUMMARY OF THE INVENTION

One of the objectives of the present invention is to provide a liquid crystal display panel and a method of liquid crystal alignment thereof including utilizing a specific design of electrode and providing the voltage in the process of liquid crystal alignment such that the arrangement order of the liquid crystal molecules can be improved, the appearance of dark lines can be decreased, and the transmittance can be increased.

To achieve the above objective, one of the embodiments of the present invention provides a liquid crystal display panel that includes a first substrate, a conductive line, an active switch device, a pixel electrode, a first electrode, a second substrate, a plurality of liquid crystal molecules and second electrode. The conductive line is disposed on the first substrate and extends along a first direction. The active switch device is disposed on the first substrate and electrically connected to the conductive line. The pixel electrode is disposed on the first substrate and electrically connected to the active switch device, wherein the pixel electrode has a cruciform opening, which includes a first slit extending along a first direction and a second slit extending along a second direction intersecting the first slit. The first electrode is disposed on the first substrate and located adjacent to a periphery of the pixel electrode. The second substrate is disposed opposite to the first substrate. The liquid crystal molecules are disposed between the first substrate and the second substrate. The second electrode is disposed on the second substrate. The pixel electrode includes two first parts and a second part, where the two first parts are disposed adjacent to two opposite ends of the second slit in the second direction respectively, a distance between the two first parts in the second direction has a first width, the second part has a second width in second direction, and the first width is greater than the second width.

To achieve the above objective, one of the embodiments of the present invention provides a method of liquid crystal alignment. The method includes providing the liquid crystal display panel which is above-mentioned, wherein the liquid crystal molecules are mixed with a plurality of photo-curing monomers. The pretilt angle of the liquid crystal molecules is generated by providing the first electrode with a first voltage, providing the second electrode with a second voltage, and providing the pixel electrode with a third voltage via the active switch device. In the condition of providing the first voltage, the second voltage and the third voltage, light is utilized for exposing the photo-curing monomers, such that the photo-curing monomers are polymerized as a first polymer-stabilized alignment layer and a second polymer-stabilized alignment layer, which fix the pretilt angle of the liquid crystal molecules, on the first substrate and the second substrate respectively, wherein a difference value according to a root-mean-square value of the first voltage and a root-mean-square value of the second voltage is greater than a difference value according to a root-mean-square value of the third voltage and the root-mean-square value of the second voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the direction which the liquid crystal molecules of liquid crystal display panel lie down towards according to the comparison embodiment of the present invention.

FIG. 2 is an optical microscope picture of the comparison embodiment of the present invention.

FIG. 3 is a schematic diagram illustrating the direction which the liquid crystal molecules of liquid crystal display panel lie down towards according to an embodiment of the present invention.

FIG. 4 is an optical microscope picture of the embodiment of the present invention.

FIG. 5 is a schematic diagram of the top view of the liquid crystal display panel according to the first embodiment of the present invention.

FIG. 6 is a cross-sectional view diagram taken along cross-sectional line, A-A′, of the liquid crystal display panel in FIG. 5.

FIG. 7 is a cross-sectional view diagram taken along cross-sectional line, B-B′, of the liquid crystal display panel in FIG. 5.

FIG. 8 is a cross-sectional view diagram taken along cross-sectional line, C-C′, of the liquid crystal display panel in FIG. 5.

FIG. 9 to FIG. 11 are schematic diagrams illustrating the method of liquid crystal alignment of the liquid crystal display panel according to an embodiment of the present invention.

FIG. 12 is a schematic diagram of the top view of the liquid crystal display panel according to the second embodiment of the present invention.

FIG. 13 is a cross-sectional view diagram taken along cross-sectional line, D-D′, of the liquid crystal display panel in FIG. 12.

FIG. 14 is a schematic diagram of the top view of the liquid crystal display panel according to the third embodiment of the present invention.

FIG. 15 is a cross-sectional view diagram taken along cross-sectional line, E-E′, of the liquid crystal display panel in FIG. 14.

FIG. 16 is a schematic diagram of the top view of the liquid crystal display panel according to the fourth embodiment of the present invention.

FIG. 17 is a cross-sectional view diagram taken along cross-sectional line, F-F′, of the liquid crystal display panel in FIG. 16.

FIG. 18 is a cross-sectional view diagram taken along cross-sectional line, G-G′, of the liquid crystal display panel in FIG. 16.

FIG. 19 is a schematic diagram of the top view of the liquid crystal display panel according to the fifth embodiment of the present invention.

FIG. 20 is a schematic diagram of the top view of the liquid crystal display panel according to the sixth embodiment of the present invention.

FIG. 21 is a schematic diagram of the top view of the liquid crystal display panel according to a variant embodiment of the sixth embodiment of the present invention.

FIG. 22 is a schematic diagram of the top view of the liquid crystal display panel according to the seventh embodiment of the present invention.

FIG. 23 is a schematic diagram of the top view of the liquid crystal display panel according to the eighth embodiment of the present invention.

FIG. 24 is a schematic diagram of the top view of the liquid crystal display panel according to the ninth embodiment of the present invention.

FIG. 25 is a schematic diagram of the top view of the liquid crystal display panel according to the tenth embodiment of the present invention.

### DETAILED DESCRIPTION

To provide a better understanding of the present invention to the skilled users in the technology of the present invention, preferred embodiments will be detailed as follows. The preferred embodiments of the present invention are illustrated in the accompanying drawings with numbered elements to elaborate the contents and effects to be achieved.

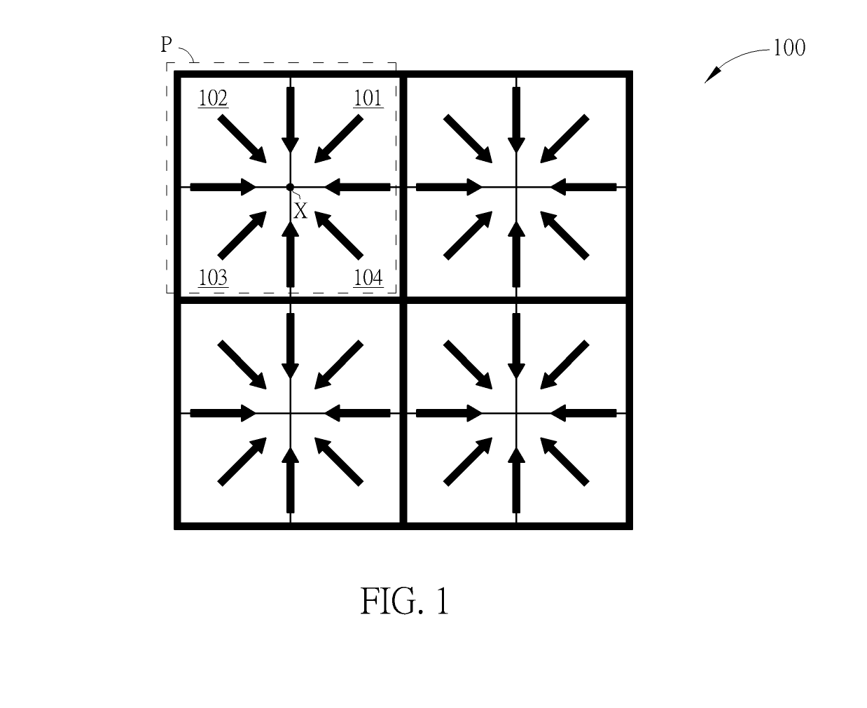

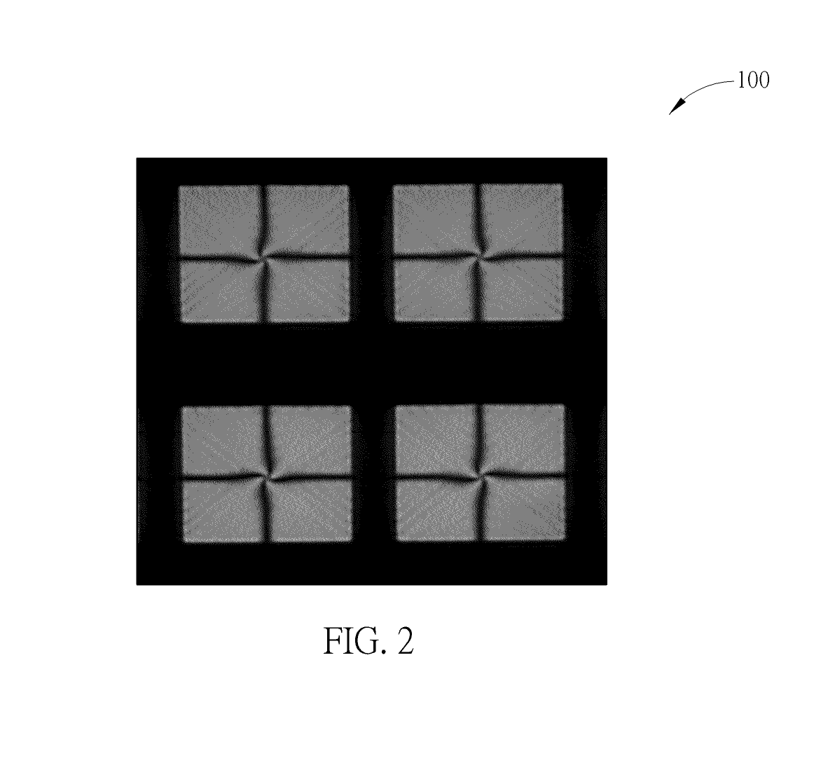

Referring to FIG. 1 and FIG. 2, FIG. 1 is a schematic diagram illustrating the direction which the liquid crystal molecules of liquid crystal display panel lie down towards according to the comparison embodiment of the present invention, and FIG. 2 is an optical microscope picture of the comparison embodiment of the present invention. As shown in FIG. 1, the liquid crystal display panel 100 of the comparison embodiment includes a plurality of pixels P, wherein each pixel P includes a plurality of alignment areas, for example a first alignment area 101, a second alignment area 102, a third alignment area 103 and a fourth alignment area 104. In the comparison embodiment, the liquid crystal molecules of the first alignment area 101, the second alignment area 102, the third alignment area 103 and the fourth alignment area 104 lie down towards different directions which are respectively towards the centers X of the boundaries of all the alignment area when they are driven, as shown by the arrows in FIG. 1. When the liquid crystal molecules lie down towards the centers X, the liquid crystal molecules positioned around the boundary between adjacent alignment areas have an inconsistent arrangement caused by disturbing each other, resulted in that the center dark line is thick and the transmittance of the liquid crystal display panel 100 is decreased. As shown in FIG. 2, the dark lines at the centers of boundaries between four adjacent alignment areas and the boundaries between any two adjacent alignment areas of the liquid crystal display panel 100 of the comparison embodiment are both evident, and the transmittance and the display effect are influenced strongly.

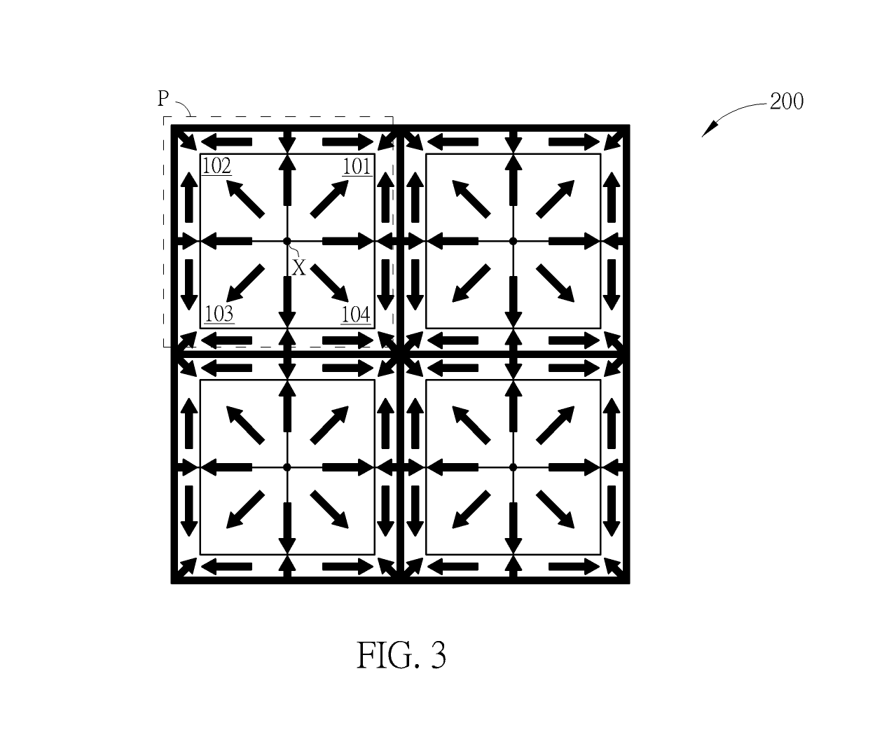

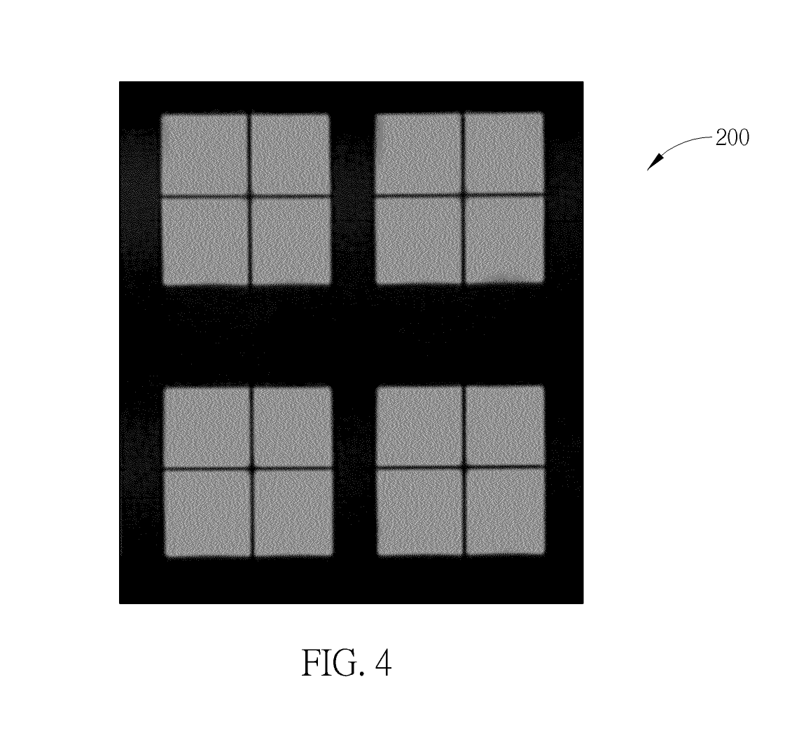

Referring to FIG. 3 and FIG. 4, FIG. 3 is a schematic diagram illustrating the direction which the liquid crystal molecules of liquid crystal display panel lie down towards according to an embodiment of the present invention, and FIG. 4 is an optical microscope picture of the embodiment of the present invention. As shown in FIG. 3, in the liquid crystal display panel 200 of the embodiment of the present invention, the liquid crystal molecules of the first alignment area 101, the second alignment area 102, the third alignment area 103 and the fourth alignment area 104 lie down outwards and opposite to the centers X of the alignment areas when they are driven, as shown by the arrows in FIG. 3. Therefore, the liquid crystal molecules have a consistent and regular arrangement and do not disturb each other. In addition, the liquid crystal molecules situated inside the first alignment area 101, the second alignment area 102, the third alignment area 103 or the fourth alignment area 104 but inside the surrounding of the pixel electrode (i.e. on the periphery of the pixel electrode) substantially lie down towards the parallel direction with the boundaries between any two adjacent alignment areas. As shown in FIG. 4 and making a comparison with the comparison embodiment, the dark lines at the center of boundaries between four adjacent alignment areas or the boundaries between any two adjacent alignment areas of the liquid crystal display panel 200 of the embodiment are thinner and not obvious. Thus, the transmittance and the display effect are increased.

All kinds of embodiments of the present invention having the technical feature which the liquid crystal molecules lie down outwards and opposite to the center are described below in detail.

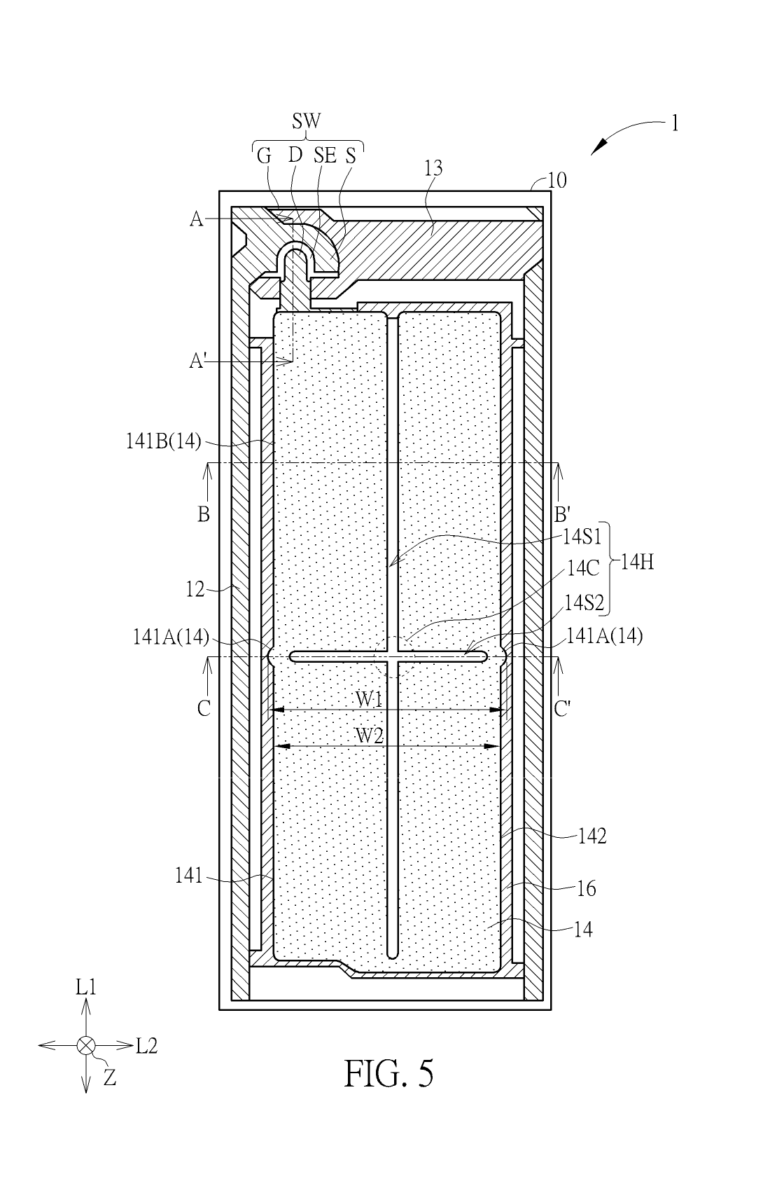

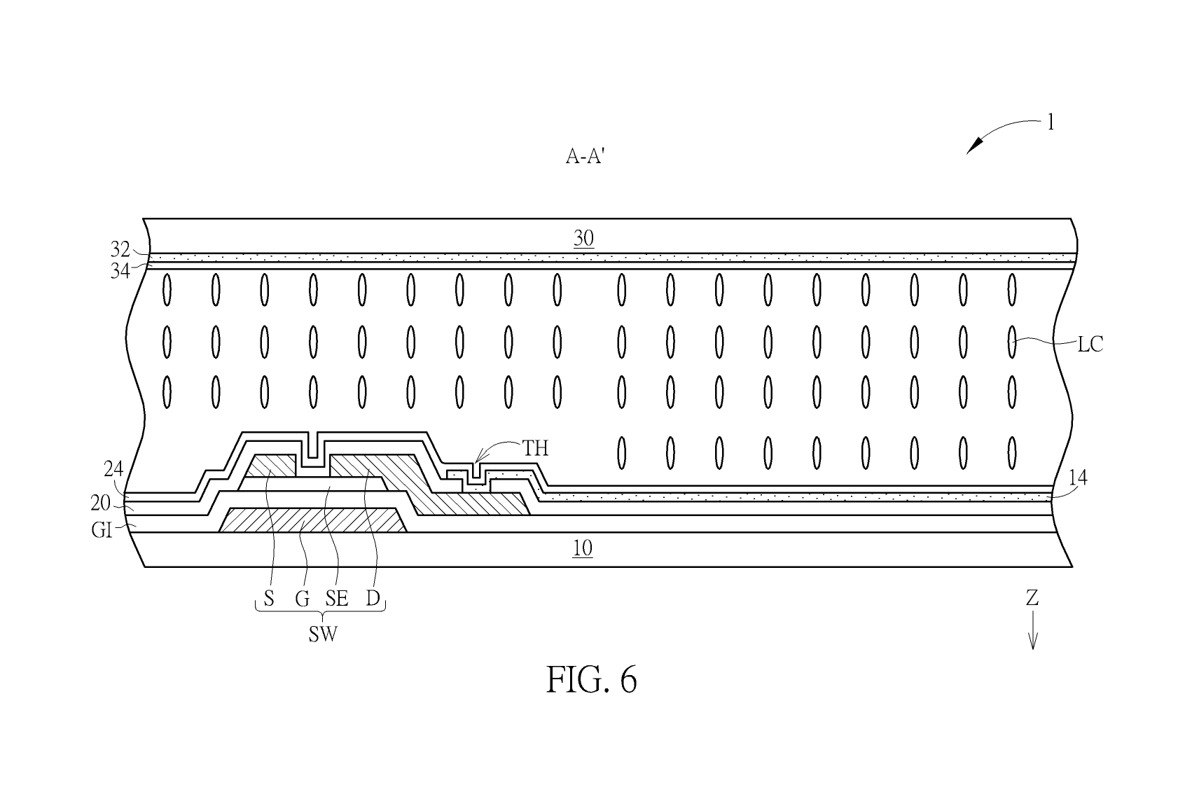

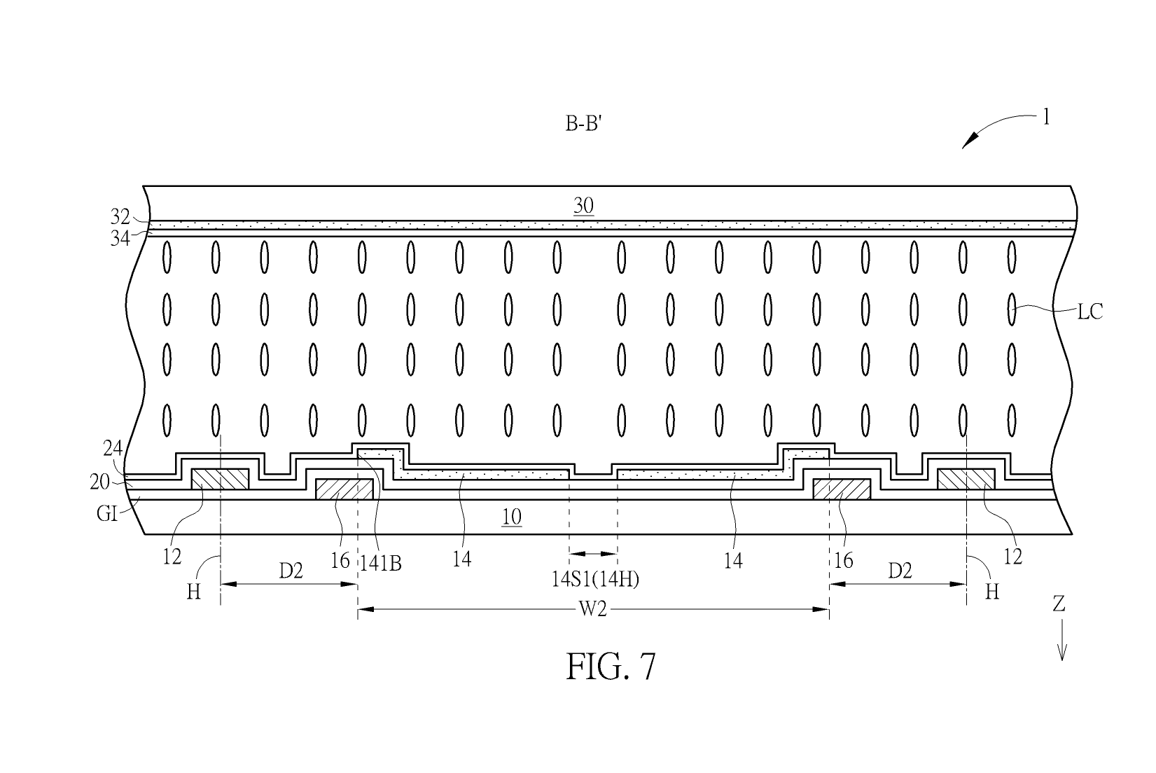

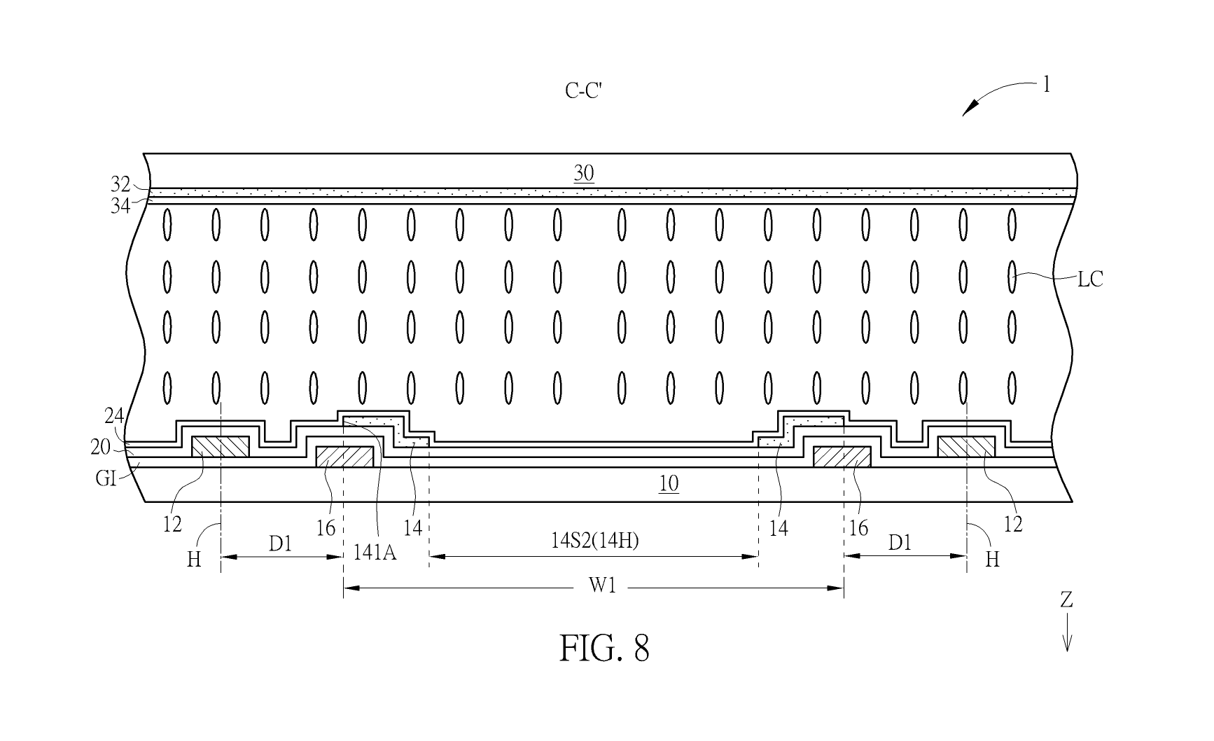

Referring to FIG. 5 to FIG. 8, FIG. 5 is a schematic diagram of the top view of the liquid crystal display panel according to the first embodiment of the present invention. FIG. 6 is a cross-sectional view diagram taken along cross-sectional line A-A′ of the liquid crystal display panel in FIG. 5. FIG. 7 is a cross-sectional view diagram taken along cross-sectional line B-B′ of the liquid crystal display panel in FIG. 5. FIG. 8 is a cross-sectional view diagram taken along cross-sectional line C-C′ of the liquid crystal display panel in FIG. 5. In order to highlight the features of the present invention, the schematic diagrams only illustrate one pixel structure. As shown in FIG. 5 to FIG. 8, the liquid crystal display panel 1 of the first embodiment includes a first substrate 10, a conductive line 12, an active switch device SW, a pixel electrode 14, a first electrode 16, a second substrate 30, a second electrode 32 and liquid crystal molecules LC. The first substrate 10 may be a transparent substrate such as a glass substrate, a plastic substrate, quartz substrate, sapphire substrate or other suitable rigid substrates or flexible substrates. The conductive line 12 is disposed on the first substrate 10, wherein the conductive line 12 extends along a first direction L1. The conductive line 12 of the this embodiment is a data line, and the liquid crystal display panel 1 may further includes a conductive line 13, wherein the conductive line 13 may be a gate line and not disposed in parallel with the conductive line 12. For example, the conductive line 13 may extend along a second direction L2. The first direction L1 and the second direction L2 may be substantially perpendicular to each other. For example, the first direction L1 extends along the vertical direction of FIG. 5 and the second direction L2 extends along the horizontal direction of FIG. 5, but not limited thereto. In this embodiment, the active switch device SW may be a bottom gate thin film transistor including a gate G, a semiconductor channel layer SE, a source S and a drain D, wherein the conductive line (gate line) 13 and the gate G may belong to a same patterned conductive layer (for example the first metal layer) and be electrically connected to each other. The conductive line (data line) 12, the source S and the drain D may belong to a same patterned conductive layer (for example the second metal layer), and the conductive line 12 and the source S are electrically connected to each other, but not limited thereto. In addition, a gate insulating layer GI may be disposed between the gate G and the semiconductor channel layer SE. In a variant embodiment, the active switch device SW may be a top gate thin film transistor or other thin film transistors.

The pixel electrode 14 is disposed on the first substrate 10. For example, the pixel electrode 14 is disposed on at least one protective layer 20, and the pixel electrode 14 may be electrically connected to the drain D via a contact hole TH of the protective layer 20. The active switch device SW and the conductive lines 12, 13 are disposed under the protective layer 20. The second substrate 30 and the first substrate 10 are disposed opposite to each other, wherein the second substrate 30 may be a transparent substrate such as a glass substrate, a plastic substrate, a quartz substrate, a sapphire substrate or other suitable rigid substrates or flexible substrates. The second electrode 32 is disposed on the second substrate 30, the second electrode 32 may be a common electrode, and it may be a planar electrode, but not limited thereto. The material of the second electrode 32 may be a transparent conductive material such as indium tin oxide (ITO), indium zinc oxide (IZO) or other suitable transparent conductive materials. The liquid crystal molecules LC are disposed between the first substrate 10 and the second substrate 30. The liquid crystal display panel 1 of this embodiment may further include alignment layers 24, 34, wherein the alignment layer 24 may be disposed on the first substrate 10, above the pixel electrode 14, and the alignment layer 34 may be disposed on the second substrate 30 and the second electrode 32. A polymer material having side chain (s) may be selected for forming the alignment layers 24, 34, and the dielectric constant of the alignment layers 24, 34 may be greater than the perpendicular dielectric constant of the liquid crystal molecules LC. For example, the material of the alignment layers 24, 34 may include polyimide, but not limited thereto. In addition, the liquid crystal display panel 1 may further include a color filter layer (not shown in figure), a light-shielding pattern, for example black matrix (not shown in figure), or other devices, and thus will not be redundantly described.

According to this embodiment, the pixel electrode 14 has a cruciform opening 14H, wherein the cruciform opening 14H includes a first slit 14S1 extending along a first direction L1 and a second slit 14S2 extending along a second direction L2. The second slit 14S2 intersects the first slit 14S1, the cruciform opening 14H substantially divides the pixel electrode 14 in a plurality of alignment areas, and an intersection 14C is formed by the first slit 14S1 and the second slit 14S2. According to this embodiment, except for the first slit 14S1 and the second slit 14S2, the pixel electrode 14 may be a planar electrode substantially, but not limited thereto. For example, the pixel electrode 14 may selectively include branch slits. The pixel electrode 14 may be a transparent electrode. The material of the pixel electrode 14 may indium tin oxide (ITO), indium zinc oxide (IZO) or other suitable transparent conductive materials, but not limited thereto. According to this embodiment, a width of the first slit 14S1 in the second direction L2 and a width of the second slit 14S2 in the first direction L1 are substantially between 1 micrometer (μm) and 12 micrometers (μm), for example substantially between 1 micrometer (μm) and 8 micrometers (μm), but not limited thereto. The width of the first slit 14S1 in the second direction L2 is equal to or not equal to the width of the second slit 14S2 in the first direction L1. In addition, a ratio of a length of the first slit 14S1 in the first direction L1 and a length of the pixel electrode 14 in the first direction L1 is substantially greater than or equal to 0.5 and less than 1, and a ratio of a length of the second slit 14S2 in the second direction L2 and a length of the pixel electrode 14 in the second direction L2 is substantially greater than or equal to 0.5 and less than 1, but not limited thereto. Furthermore, the length of the first slit 14S1 in the first direction L1 can be equal to or not equal to the length of the second slit 14S2 in the second direction L2, which can be adjusted depending on the pattern of the pixel.

In addition, the first electrode 16 is disposed on the first substrate 10 and adjacent to the pixel electrode 14, surrounding the pixel electrode 14. Precisely, observing from the top view, the first electrode 16 is disposed on the first substrate 10 and located adjacent to a periphery of the pixel electrode 14. The material of the first electrode 16 may be a non-transparent conductive material such as metals, alloys or other suitable non-transparent conductive materials, a transparent conductive material such as indium tin oxide (ITO), indium zinc oxide (IZO) or other suitable transparent conductive materials, macromolecule materials or other suitable conductive materials. According to this embodiment, the first electrode 16 is disposed between the pixel electrode 14 and the first substrate 10, and the first electrode 16 and the pixel electrode 14 overlap partially in a vertical projection direction Z. The first electrode 16 and the pixel electrode 14 may belong to different patterned conductive layers. For example, the first electrode 16, the conductive line 13 (gate line) and the gate G belong to a same patterned conductive layer, but not limited thereto. Furthermore, because the protective layer 20 covers the first electrode 16, and the pixel electrode 14 is disposed on the protective layer 20 and overlaps the first electrode 16, the overlapping part of the pixel electrode 14 and the first electrode 16 is a projection structure. In other words, the overlapping part of the pixel electrode 14 and the first electrode 16 forms a raised landform.

Moreover, the pixel electrode 14 has a first side edge 141 and a second side edge 142 which are opposite to each other, the first side edge 141 is adjacent to the conductive line 12, and the second side edge 142 is adjacent to another conductive line 12. For example, as shown in FIG. 5, the first side edge 141 is the left side edge of the pixel electrode 14 and the second side edge 142 is the right side edge of the pixel electrode 14, but not limited thereto. In addition, the pixel electrode 14 includes two first parts 141A and a second part 141B, in which the second part 141B is the main portion of the pixel electrode 14 and the two first parts 141A are respectively disposed at the first side edge 141 and the second side edge 142 and adjacent to two opposite ends of the second slit 14S2 of the cruciform opening 14H in the second direction respectively. The first parts 141A and the second slit 14S2 may align in the second direction L2. A distance between the two first parts 141A in the second direction L2 has a first width W1 (as shown in FIG. 5 and FIG. 8), the second part 141B has a second width W2 in the second direction L2 (as shown in FIG. 5 and FIG. 7), and the first width W1 is greater than the second width W2. According to this embodiment, the conductive line 12 is disposed on an outer side of the pixel electrode 14 and not overlapping with the pixel electrode 14 in a vertical projection direction Z. In addition, the two first parts 141A protrude from the second part 141B along the second direction L2 and confront the conductive line 12, a minimum of distance between the first parts 141A and a center of the conductive line 12 is a first distance D1, a minimum of distance between the second part 141B and the center of the conductive line 12 is a second distance D2, and the first distance D1 is less than the second distance D2. According to this embodiment, the center of the conductive line 12 is situated on the center phantom line H of the conductive line 12. Because the conductive line 12 of this embodiment of the present invention extends along the first direction L1, whether the width of the conductive line 12 in second direction L2 is equal or not, the center phantom line H of the conductive line 12 is a straight line extending along the first direction L1. The first distance D1 is the minimum distance (perpendicular distance) between the first parts 141A and the center phantom line H of the conductive line 12, the second distance D2 is the minimum distance (perpendicular distance) between the second part 141B and the center phantom line H of the conductive line 12. In addition, the two first parts 141A are disposed between the second part 141B and its corresponding conductive line 12 respectively, and they are substantially corresponding to the two opposite ends of the second slit 14S2 of the cruciform opening 14H. According to this embodiment, the distance between the first side edge 141 of the pixel electrode 14 and the center of the conductive line 12 is approximately constant. For example, the first parts 141A may be such as bumps protruding from the second part 141B along the second direction L2, and the second part 141B may have side edges which are parallel with the first direction L1 and interiorly shrink at the first parts 141A along the second direction L2, such that the first distance D1 is less than the second distance D2. According to this embodiment, the difference between the second distance D2 and the first distance D1 is greater than 2 micrometers (μm) and less than or equal to 10 micrometers (μm), but not limited thereto. According to a variant embodiment, the distance between the first side edge 141 of the pixel electrode 14 and the center of the conductive line 12 may not be constant and have variation, and the variation may be continuous or discontinuous. Especially, the second side edge 142 of the pixel electrode 14 may face the conductive line 12 of the adjacent pixel, and the design of the second side edge 142 may be the same design as the first side edge 141. In addition, according to the variant embodiment, the conductive line 12 may be the gate line, and the conductive line 13 may be a data line. That is to say, the first side edge 141 and the second side edge 142 of the pixel electrode 14 may be the two side edges which face the side edge of different gate lines respectively.

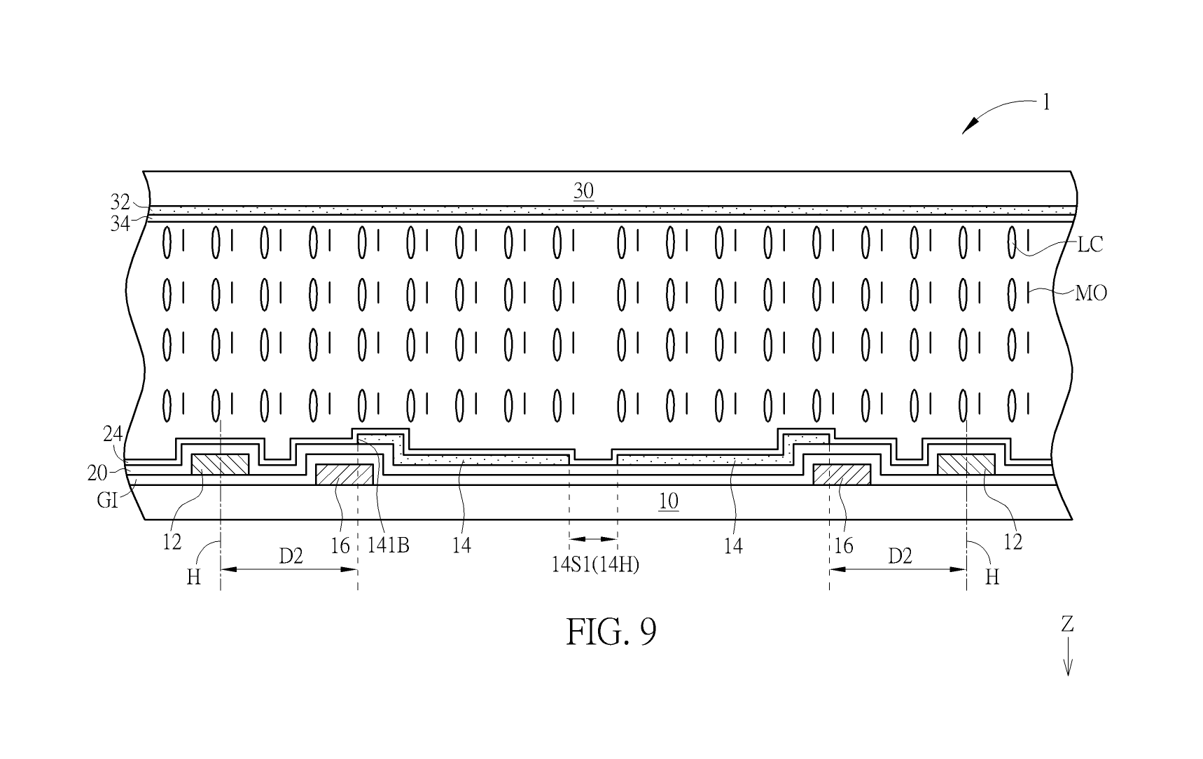

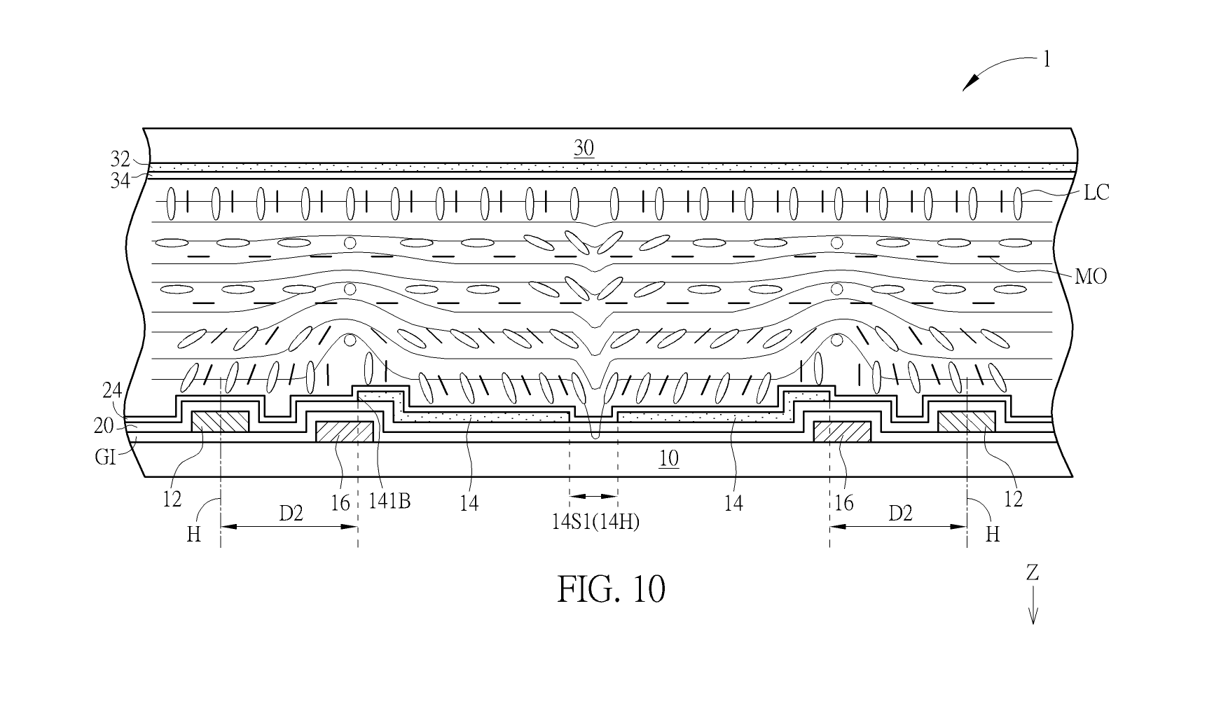

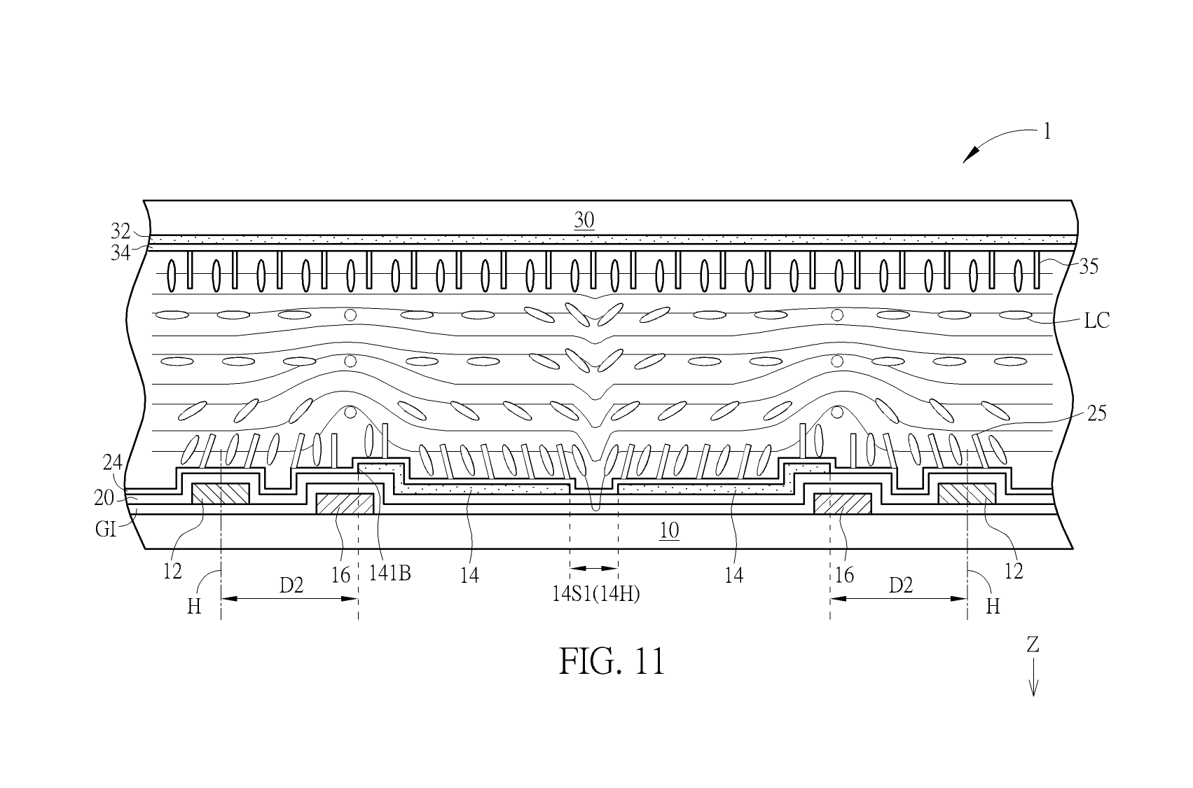

The liquid crystal display panel 1 of the embodiment of the present invention is the Polymer-Stabilized Alignment (PSA) liquid crystal display panel. Therefore, the liquid crystal molecules LC need to be aligned by the process of liquid crystal alignment. According to this embodiment, the cruciform opening 14H of the pixel electrode 14 can reduce the boundary area of the liquid crystal alignment areas which are situated at two opposite sides of the cruciform opening 14H. In addition, in the condition of the pixel electrode 14 and the first electrode 16 overlapping in a vertical projection direction Z, apply appropriate voltages to the pixel electrode 14, the first electrode 16 and the second electrode 32 in the process of liquid crystal alignment for adjusting the electric field, so as to make the liquid crystal molecules LC lie down outwards continuously. Accordingly, the problem of the dark line can be improved. The method of liquid crystal alignment is described by the following embodiments of the present invention. Referring to FIG. 9 to FIG. 11, and also referring to FIG. 5 to FIG. 8 simultaneously, FIG. 9 to FIG. 11 are schematic diagrams illustrating the method of liquid crystal alignment of the liquid crystal display panel according to the embodiment of the present invention. As shown in FIG. 9, first, the liquid crystal molecules LC of the liquid crystal display panel 1 are mixed with photo-curing monomers MO. As shown in FIG. 10, the first electrode 16 is provided with a first voltage, the second electrode 32 is provided with a second voltage, and the pixel electrode 14 is provided with a third voltage via the active switch device SW, such that a pretilt angle of the liquid crystal molecules LC nearby the alignment layers 24 of the first substrate 10 is generated by the electric field caused by the first voltage, the second voltage and the third voltage. As shown in FIG. 11, in the condition of providing the first voltage, the second voltage and the third voltage, the photo-curing monomers MO are exposed by the light (for example the UV light), such that the photo-curing monomers MO polymerize as a first polymer-stabilized alignment layer 25 and a second polymer-stabilized alignment layer 35, which fix the pretilt angle of the liquid crystal molecules LC, on the first substrate 10 and the second substrate 20 respectively. According to this embodiment, a difference value according to a root-mean-square value of the first voltage and a root-mean-square value of the second voltage is greater than a difference value according to a root-mean-square value of the third voltage and the root-mean-square value of the second voltage. For example, in the process of liquid crystal alignment, a difference value between the difference value according to the root-mean-square value of the first voltage and the root-mean-square value of the second voltage and the difference value according to the root-mean-square value of the third voltage and the root-mean-square value of the second voltage is greater than or equal to 1 volt (V), wherein the difference value according to the root-mean-square value of the first voltage and the root-mean-square value of the second voltage may be such as 8 volts, and the difference value according to the root-mean-square value of the third voltage and the root-mean-square value of the second voltage may be such as 5 volts, but not limited thereto. For another example, according to an embodiment, the second voltage may be a ground voltage, the first voltage may be 24 volts, and the third voltage may be 23 volts; according to another embodiment, the third voltage may be a ground voltage, the first voltage may be −21 volts, and the second voltage may be −10 volts, but not limited thereto.

In the condition of providing the first electrode 16 with the first voltage, providing the second electrode 32 with the second voltage and providing the pixel electrode 14 with the third voltage, the equipotential lines corresponding to the cruciform opening 14H can be changed by the design of the cruciform opening 14H of the pixel electrode 14 (as shown in FIG. 10 and FIG. 11), such that the liquid crystal molecules LC corresponding to the cruciform opening 14H lie down outwards direction (periphery of the pixel electrode 14), so the boundary area of the alignment areas which are situated at the two opposite sides of the cruciform opening 14H can be decreased. Also, the generation of the cruciform dark lines can be decreased. In addition, with the first electrode 16 located adjacent to the periphery of the pixel electrode, the two first parts 141A of the pixel electrode 14 protrude from the second part 141B, and the overlap of the pixel electrode 14 and the first electrode 16, the equipotential lines corresponding to the adjacent of pixel electrode 14 can be changed in the process of liquid crystal alignment (as shown in FIG. 10 and FIG. 11), so as to make the liquid crystal molecules LC located inside the first electrode 16 can lie down outwards continuously, such that the problem of the dark lines can be improved and the transmittance can be increased. Moreover, the liquid crystal molecules LC located outside the first electrode 16 lie down outwards and inwards substantially, and the liquid crystal molecules LC located above the first electrode 16 substantially lie down towards the direction extending along the first electrode 16.

It is noteworthy to explain that when the liquid crystal display panel 1 displays, the first voltage applied to the first electrode 16 may be equal to the second voltage applied to the second electrode 32 (the first voltage and the second voltage may be, but not limited to, both ground voltage), and the gray level can be adjusted by changing the third voltage (the pixel voltage) of the pixel electrode 14 for controlling the tilt angle of the liquid crystal molecules LC.

The liquid crystal display panel and the method of liquid crystal alignment of this invention are not limited to the above embodiments. Further embodiments of the liquid crystal display panel and the method of liquid crystal alignment are described below. To compare each embodiment conveniently and simplify the description, each embodiment has the same device labeled with the same symbol. The description just descripts the differences between each embodiment, and repeated parts will not be redundantly described.

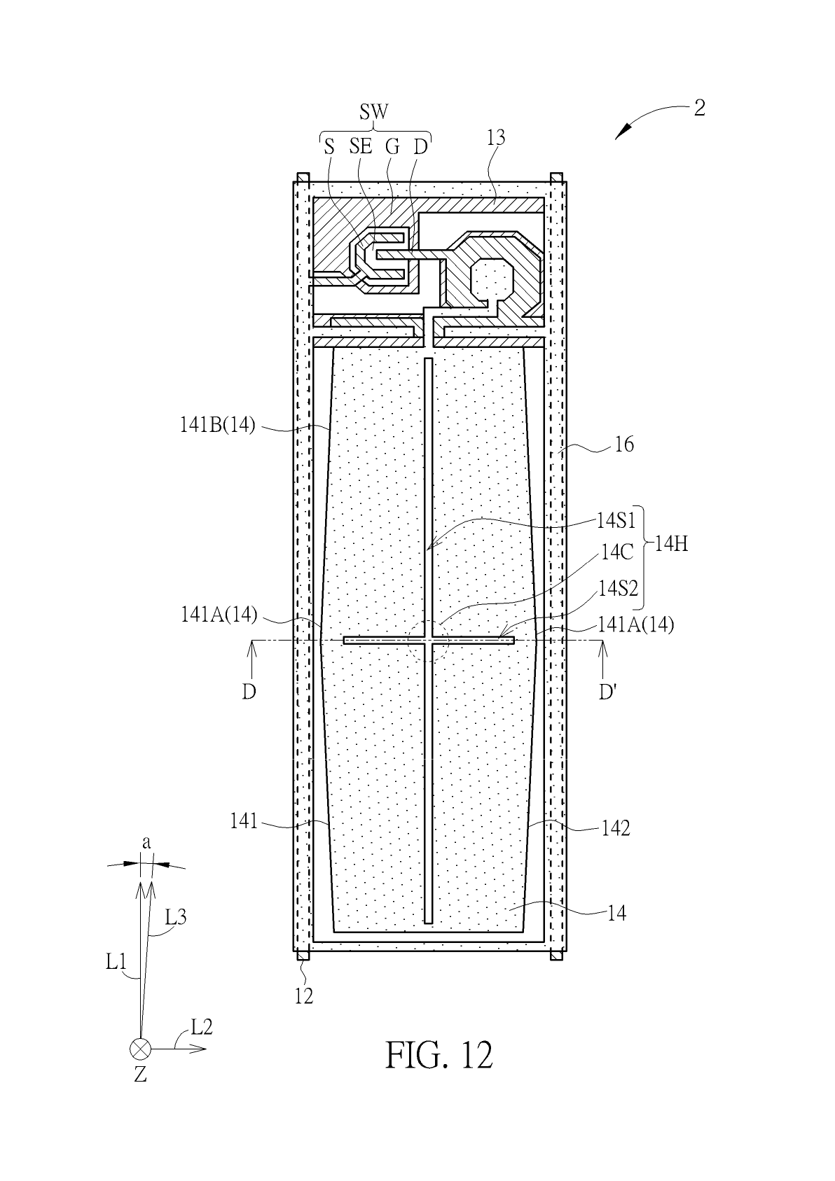

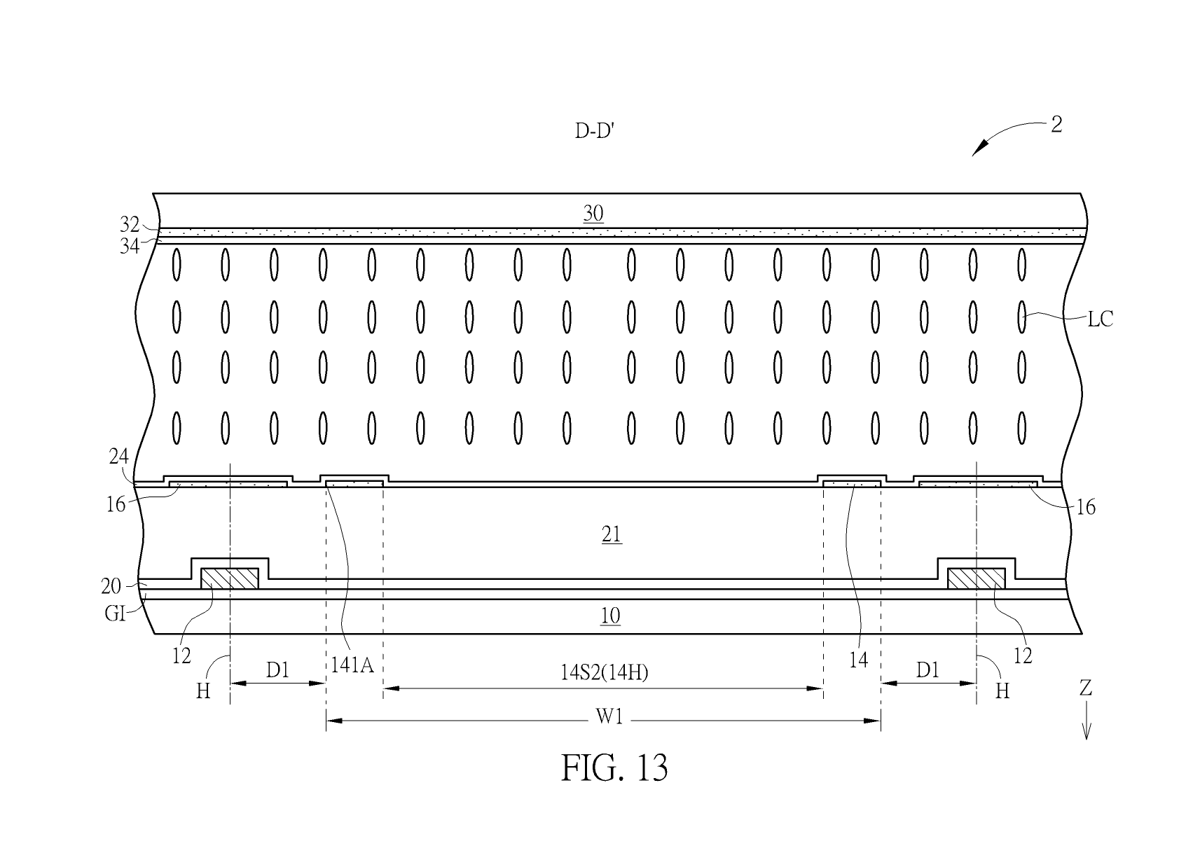

Referring to FIG. 12 and FIG. 13, FIG. 12 is a schematic diagram of the top view of the liquid crystal display panel according to the second embodiment of the present invention, and FIG. 13 is a cross-sectional view diagram taken along cross-sectional lines D-D′ of the liquid crystal display panel in FIG. 12. As shown in FIG. 12 and FIG. 13, according to the liquid crystal display panel 2 of this embodiment, the difference between this embodiment and the first embodiment is the first electrode 16 and the pixel electrode 14 belong to a same patterned conductive layer, but the first electrode 16 and the pixel electrode 14 are not electrically connected to each other. The first electrode 16 and the pixel electrode 14 may be a transparent conductive material such as ITO, IZO or other suitable transparent conductive materials. In addition, according to this embodiment, the first distance D1 between the first parts 141A of the pixel electrode 14 and the center of the conductive line 12 is also less than the second distance D2 between the second part 141B and the center of the conductive line 12 (not shown in figure). However, the difference between this embodiment and the first embodiment is that the variation of the distance between the first side edge 141 of the pixel electrode 14 and the center of the conductive line 12 is a continuous variation. For example, the second part 141B of the first side edge 141 of the pixel electrode 14 shrinks interiorly along the first direction L1 from the first part 141A. Also, the second width W2 of the second part 141B of the pixel electrode 14 decreases gradually along the first direction L1 from the first part 141A. That is to say, the first side edge 141 is disposed extending along a third direction L3, an angle included by the third direction L3 and the first direction L1 is substantially greater than 0 degrees and less than or equal to 45 degrees, but not limited thereto. According to a variant embodiment of this embodiment, the distance between the first side edge 141 of the pixel electrode 14 and the center of the conductive line 12 may be discontinuously varied, with a step-shaped variation for instance. According to this embodiment, the distance between the pixel electrode 14 and the first electrode 16 is preferably not exceeding 12 um, so as to make the liquid crystal molecules LC located at the periphery of the pixel electrode 14 lie down continuously well, but not limited thereto. According to this embodiment, the first electrode 16 and the conductive line 12 overlap in a vertical projection direction Z, therefore the liquid crystal display panel 2 may further include an insulating layer 21 disposed between the protective layer 20 and the first electrode 16, and it decreases the parasitic capacitance between the first electrode 16 and the conductive line 12, so as to prevent a large RC loading. The material, thickness and dielectric constant of the insulating layer 21 may be chosen as required. For example, the material of the insulating layer 21 may be an organic insulating material such as acrylic resin or epoxy resin, but not limited thereto. The thickness of the insulating layer 21 may be greater than the thickness of the protective layer 20, and the insulating layer 21 may have an even surface, so as to be good for disposing the first electrode 16 and the pixel electrode 14. In addition, if the liquid crystal display panel 2 of this embodiment is a color filter on array (COA) liquid crystal display panel, the insulating layer 21 and the color filter may be integrated, that is to say, the insulating layer 21 may have an effect of color filter at the same time.

With the disposure described above, in the liquid crystal display panel 2 of this embodiment, the boundary area of the alignment areas which are situated at the two opposite sides of the cruciform opening 14H can be decreased, and the liquid crystal molecules LC located inside the first electrode 16 can lie down outwards continuously. Thus, the problem of the dark lines can be improved and the transmittance can be increased.

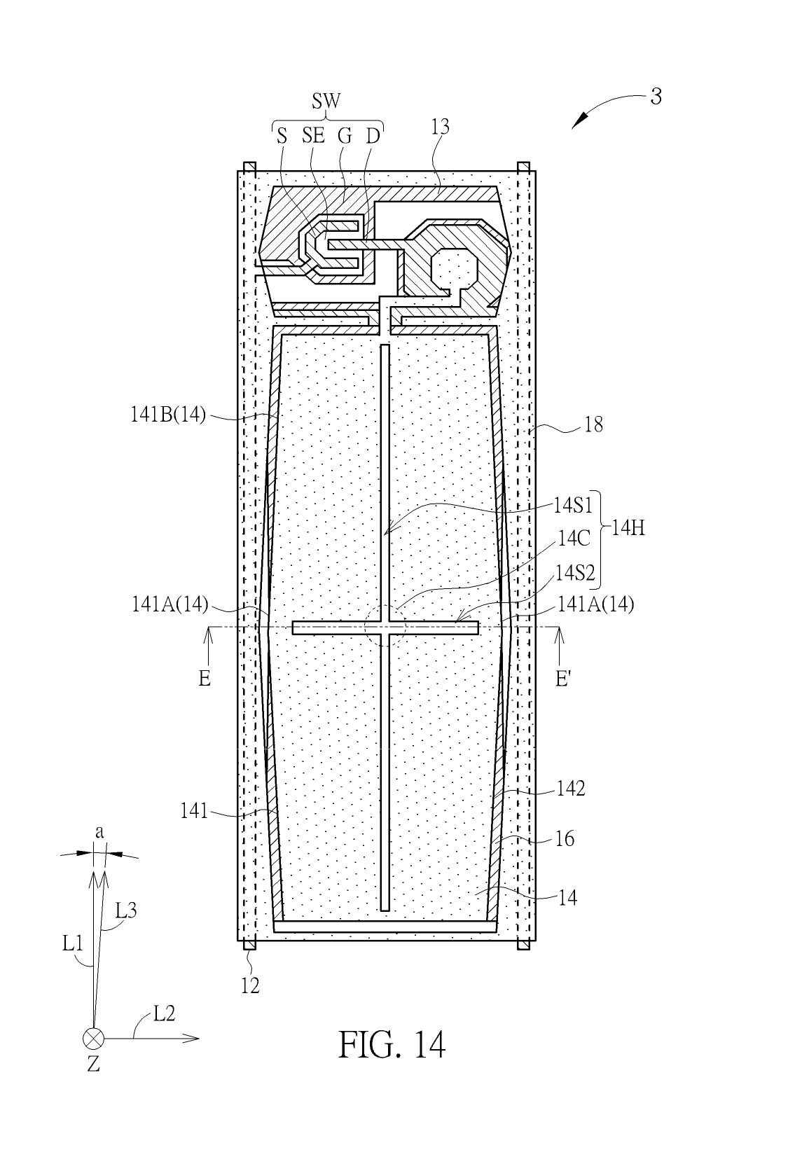

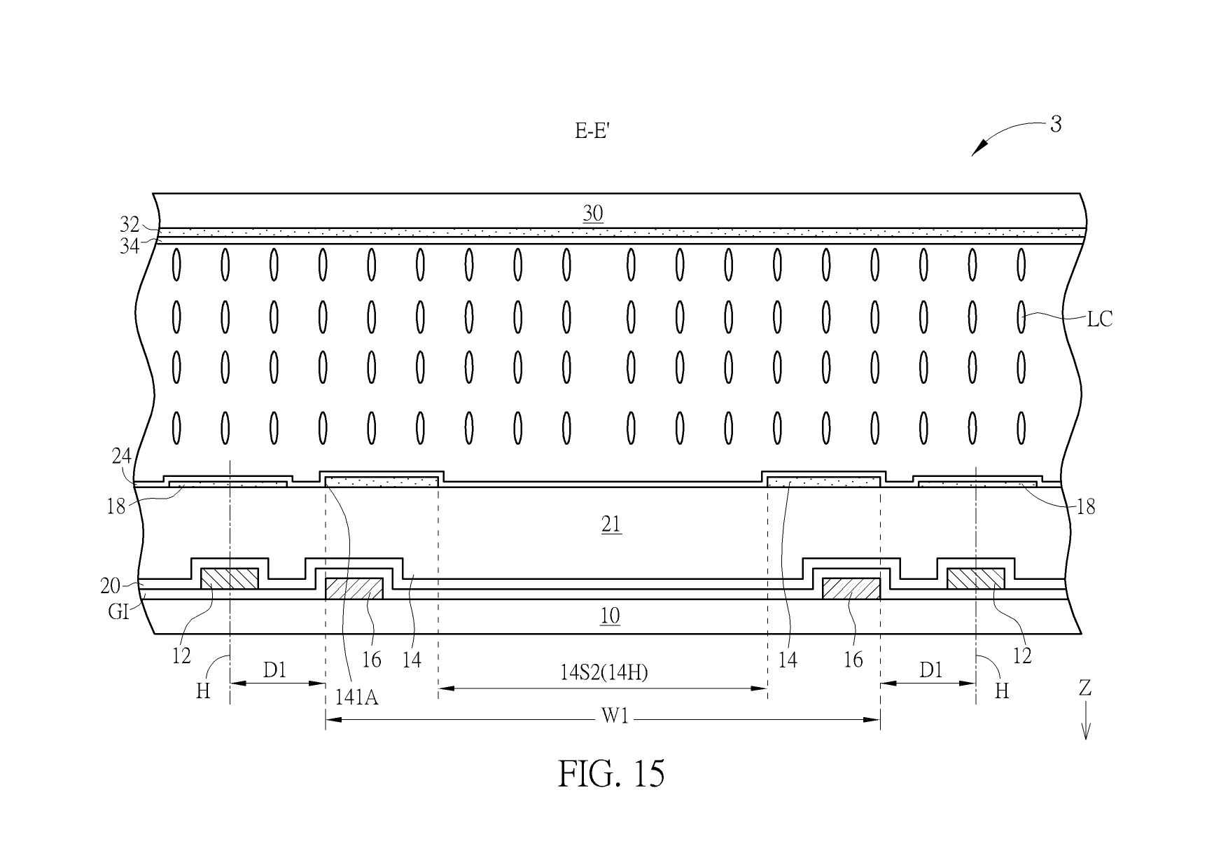

Referring to FIG. 14 and FIG. 15, FIG. 14 is a schematic diagram of the top view of the liquid crystal display panel according to the third embodiment of the present invention, and FIG. 15 is a cross-sectional view diagram taken along cross-sectional lines, E-E′, of the liquid crystal display panel in FIG. 14. As shown in FIG. 14 and FIG. 15, the difference between this embodiment and the first embodiment is the liquid crystal display panel 3 of this embodiment further includes a third electrode 18 disposed on the first substrate 10 and located adjacent to the periphery of the pixel electrode 14, and the variation of the distance between the first side edge 141 of the pixel electrode 14 and the center of the conductive line 12 is a continuous variation. According to this embodiment, the first electrode 16 and the third electrode 18 belong to different patterned conductive layers. For example, the first electrode 16 and conductive line 13 may belong to a same patterned conductive layer, and the third electrode 18 and the pixel electrode 14 may belong to same patterned conductive layer and be not electrically connected to each other, but not limited thereto. The third electrode 18 and the pixel electrode 14 may belong to different patterned conductive layers. Moreover, the third electrode 18 of this embodiment partially surrounds the pixel electrode 14, and keeps an unchanging spacing from the pixel electrode 14. Therefore, not only the second part 141B of the first side edge 141 of the pixel electrode 14 shrinks interiorly along the first direction L1 from the first part 141A, but also a side of the third electrode 18, adjacent to the pixel electrode 14, shrinks interiorly along the first direction L1, but not limited thereto. According to this embodiment, the third electrode 18 and the conductive line 12 overlap in a vertical projection direction Z, thus, the liquid crystal display panel 3 may further include an insulating layer 21 disposed between the protective layer 20 and the third electrode 18, and the insulating layer 21 decreases the parasitic capacitance between the third electrode 18 and the conductive line 12, so as to prevent a large RC loading. The material and features of the insulating layer 21 are described in the above embodiment, and thus will not be redundantly described.

Besides providing the first electrode 16 with the first voltage, providing the second electrode 32 with the second voltage and providing the pixel electrode 14 with the third voltage, the method of liquid crystal alignment of this embodiment further includes providing the third electrode 18 with a fourth voltage, wherein a difference value according to a root-mean-square value of the fourth voltage and the root-mean-square value of the second voltage is greater than the difference value according to the root-mean-square value of the third voltage and the root-mean-square value of the second voltage. For example, a difference value according to the root-mean-square value of the fourth voltage and the root-mean-square value of the second voltage is equal to the difference value according to the root-mean-square value of the first voltage and the root-mean-square value of the second voltage, that is to say, the fourth voltage is equal to the first voltage, but not limited thereto.

With the disposure described above, in the liquid crystal display panel 3 of this embodiment, the boundary area of the alignment areas which are situated at the two opposite sides of the cruciform opening 14H can be decreased, and the liquid crystal molecules LC located inside the first electrode 16 can lie down outwards continuously. Thus, the problem of the dark lines can be improved and the transmittance can be increased.

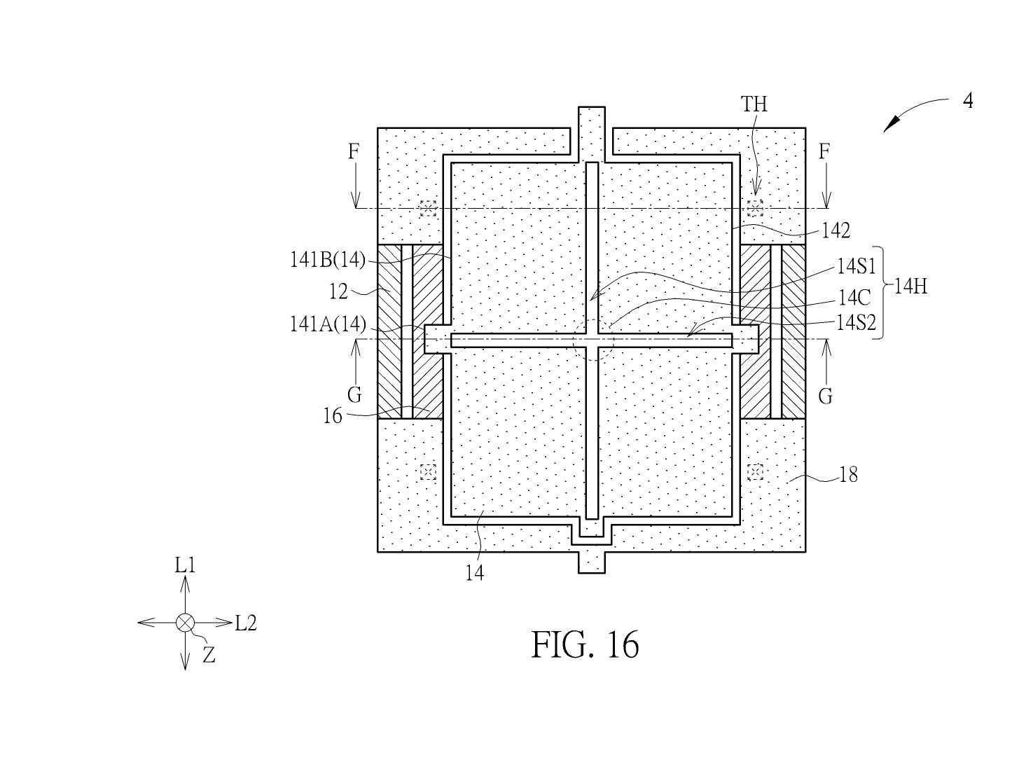

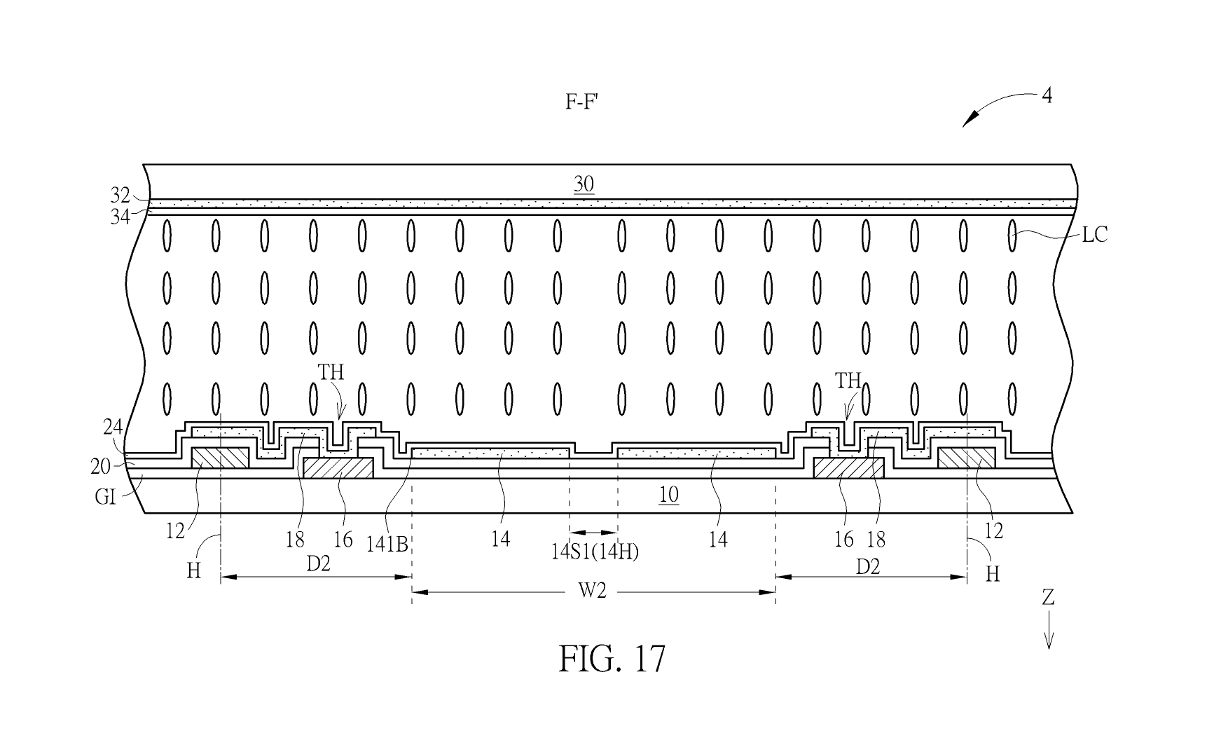

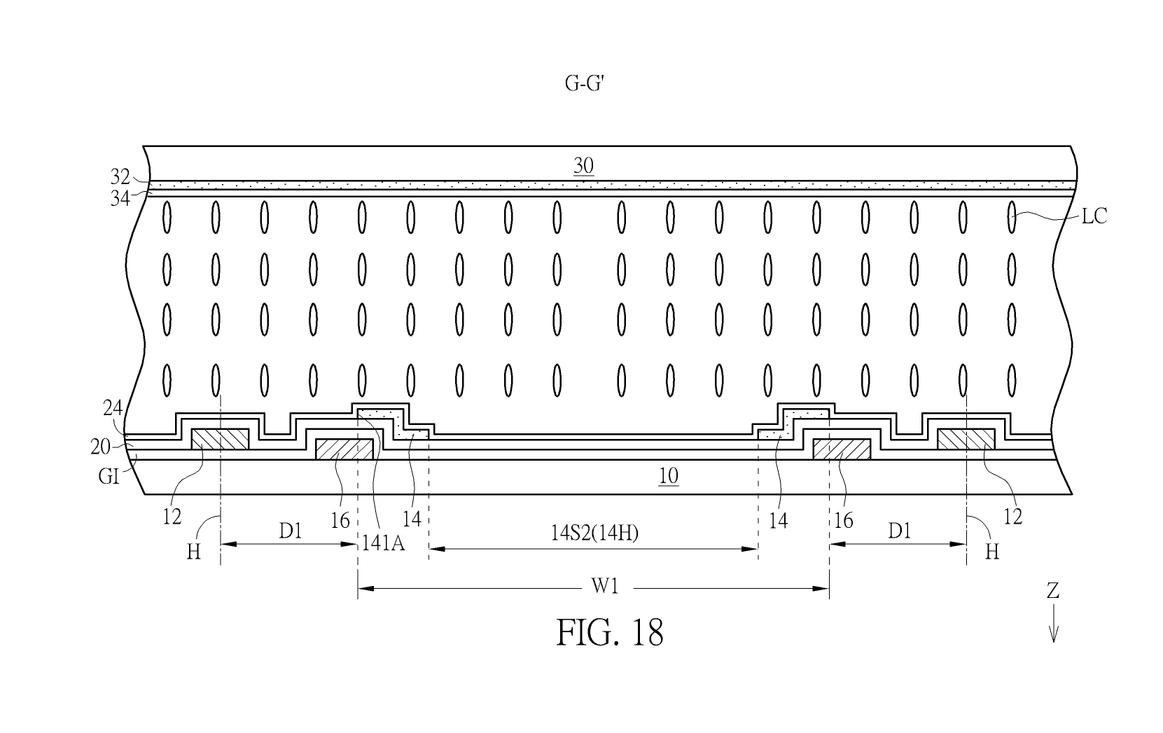

Referring to FIG. 16 to FIG. 18, FIG. 16 is a schematic diagram of the top view of the liquid crystal display panel according to the fourth embodiment of the present invention, FIG. 17 is a cross-sectional view diagram taken along cross-sectional line F-F′ of the liquid crystal display panel in FIG. 16, and FIG. 18 is a cross-sectional view diagram taken along cross-sectional line G-G′ of the liquid crystal display panel in FIG. 16, wherein to simplify the illustration, FIG. 16 does not show some devices such as the active switch device and the gate line. As shown in FIG. 16 to FIG. 18, the difference between this embodiment and the third embodiment is the first electrode 16 and the third electrode 18 are electrically connected to each other and cooperatively surrounding the pixel electrode 14 completely or partially. For example, the third electrode 18 and the pixel electrode 14 may belong to a same patterned conductive layer, and the third electrode 18 is electrically connected to the first electrode 16 via the contact hole TH of the protective layer 20 and the gate insulating layer GI. In addition, liquid crystal display panel 4 may further include an insulating layer (not shown in figure) disposed between the protective layer 20 and the third electrode 18, and the insulating layer decreases the parasitic capacitance between the third electrode 18 and the conductive line 12, wherein the material and features of the insulating layer are described in the above embodiments. According to this embodiment, the first parts 141A of the pixel electrode 14 are bumps protruding from of the second part 141B along the second direction L2 and towards the conductive line 12, but not limited thereto. According to a variant embodiment, the variation of the distance between the first side edge 141 of the pixel electrode 14 and the center of the conductive line 12 may be continuous.

With the disposure described above, in the liquid crystal display panel 4 of this embodiment, the boundary area of the alignment areas which are situated at the two opposite sides of the cruciform opening 14H can be decreased, and the liquid crystal molecules LC located inside the first electrode 16 can lie down outwards continuously. Thus, the problem of the dark lines can be improved and the transmittance can be increased.

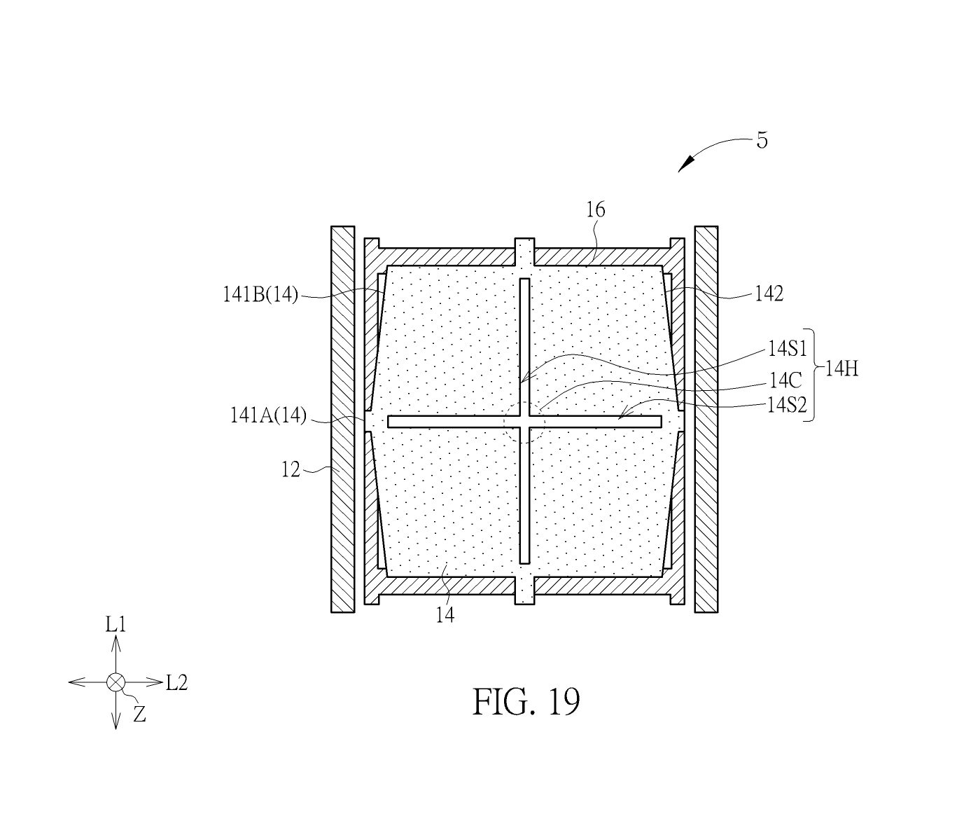

Referring to FIG. 19, FIG. 19 is a schematic diagram of the top view of the liquid crystal display panel according to the fifth embodiment of the present invention, wherein to simplify the illustration, FIG. 19 does not show some devices such as the active switch device and the gate line. As shown in FIG. 19, according to the liquid crystal display panel 5 of this embodiment, the first electrode 16 is an enclosing circular figure and surrounds the pixel electrode 14 completely, such as a hollow annular, but not limited thereto. According to this embodiment, the first electrode 16 and the pixel electrode 14 belong to different patterned conductive layers. For example, the first electrode 16 and the conductive line 13 (not shown in figure) of this embodiment may belong to a same patterned conductive layer, but not limited thereto. Moreover, the first electrode 16 and the pixel electrode 14 may partially overlap in a vertical projection direction Z.

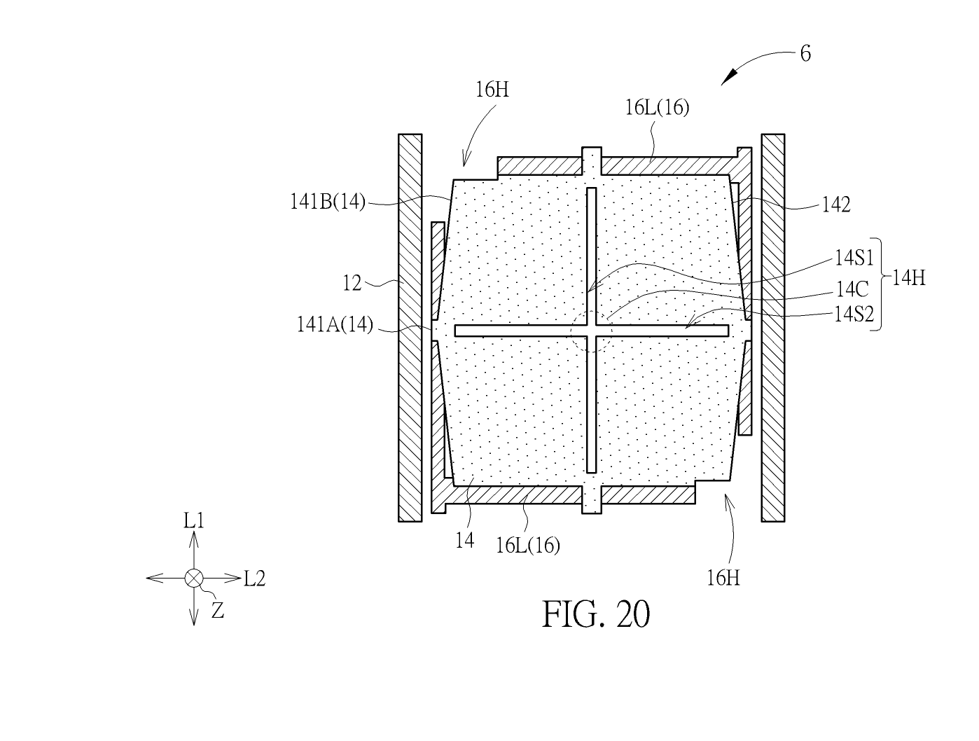

Referring to FIG. 20, FIG. 20 is a schematic diagram of the top view of the liquid crystal display panel according to the sixth embodiment of the present invention, wherein to simplify the illustration, FIG. 20 does not show some devices such as the active switch device and the gate line. As shown in FIG. 20, according to the liquid crystal display panel 6 of this embodiment, the first electrode 16 is a figure which includes at least one breach 16H and partially surrounds the pixel electrode 14. For example, the first electrode 16 may include two L shape electrodes 16L disposed at two diagonal corners of the pixel electrode 14 respectively, and the branches 16H are located between the two L shape electrodes 16L. According to this embodiment, the first electrode 16 and the pixel electrode 14 belong to different patterned conductive layers. For example, the first electrode 16 and the conductive line 13 (not shown in figure) of this embodiment may belong to a same patterned conductive layer, but not limited thereto. Moreover, the first electrode 16 and the pixel electrode 14 may partially overlap in a vertical projection direction Z.

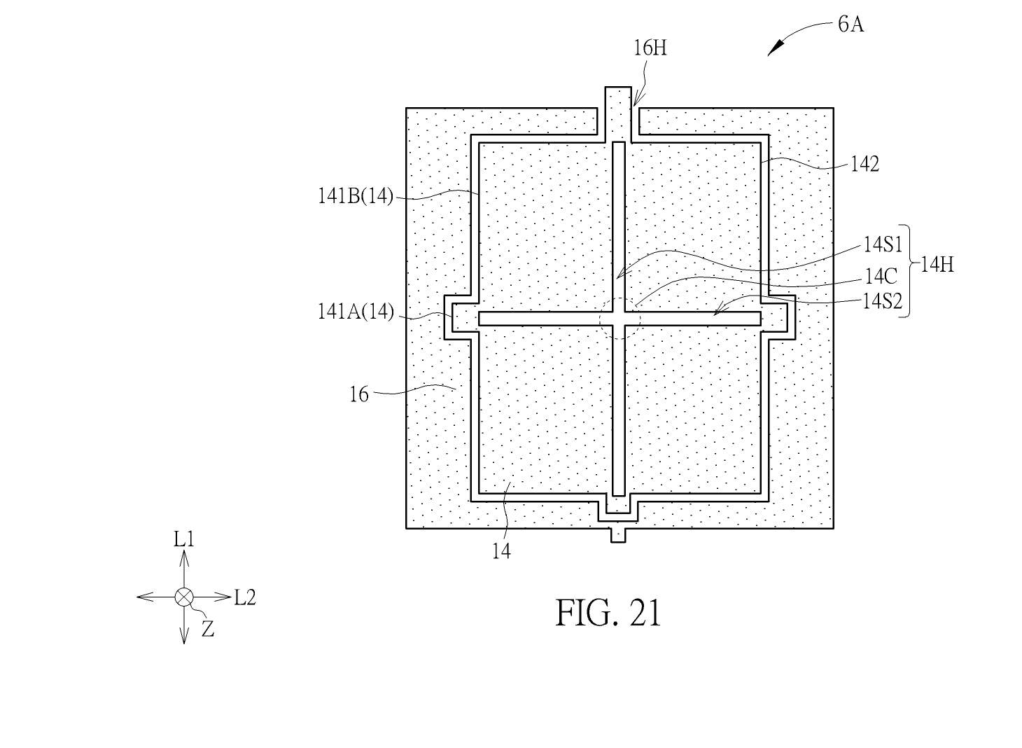

Referring to FIG. 21, FIG. 21 is a schematic diagram of the top view of the liquid crystal display panel according to a variant embodiment of the sixth embodiment of the present invention, wherein to simplify the illustration, FIG. 21 does not show some devices such as the active switch device and the gate line. As shown in FIG. 21, according to the liquid crystal display panel 6A of this embodiment, the first electrode 16 is a figure which includes at least one breach 16H and partially surrounds the pixel electrode 14. According to this embodiment, the first electrode 16 and the pixel electrode 14 belong to a same patterned conductive layer, the first electrode 16 and the pixel electrode 14 are not electrically connected to each other, and the first electrode 16 which surrounds the pixel electrode 14 keeps a constant spacing from the pixel electrode 14, but not limited thereto. In addition, a width of the first electrode 16 in the second direction L2 may be not equal to a width of the first electrode 16 in the first direction L1. For example, the width of the first electrode 16 located at the right and left sides of the pixel electrode 14 may be greater than the width of the first electrode 16 located at the top and bottom sides of the pixel electrode 14.

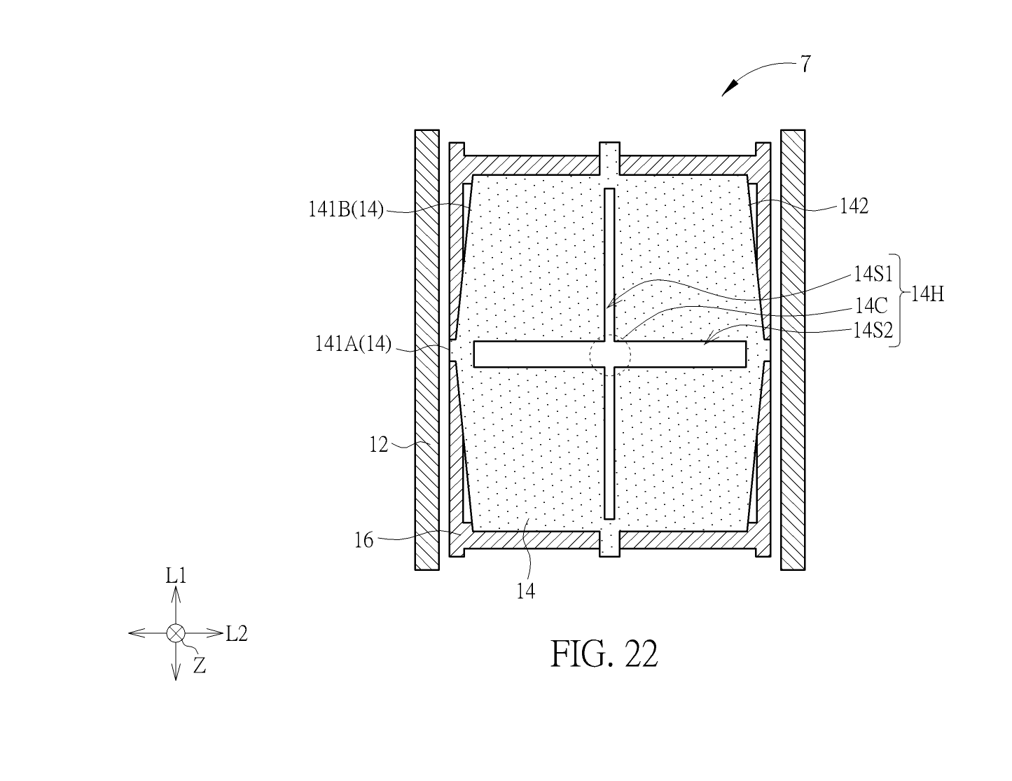

Referring to FIG. 22, FIG. 22 is a schematic diagram of the top view of the liquid crystal display panel according to the seventh embodiment of the present invention, wherein to simplify the illustration, FIG. 22 does not show some devices such as the active switch device and the gate line. As shown in FIG. 22, according to the liquid crystal display panel 7 of this embodiment, a width of the first slit 14S1 in the second direction L2 is not equal to a width of the second slit 14S2 in the first direction L1. For example, the width of the first slit 14S1 in the second direction L2 is less than the width of the second slit 14S2 in the first direction L1. According to this embodiment, the first electrode 16 and the pixel electrode 14 belong to different patterned conductive layers, but not limited thereto. In addition, a width of the first electrode 16 in the second direction L2 may be not equal to a width of the first electrode 16 in the first direction L1. For example, the width of the first electrode 16 located at the right and left sides of the pixel electrode 14 may be greater than the width of the first electrode 16 located at the top and bottom sides of the pixel electrode 14.

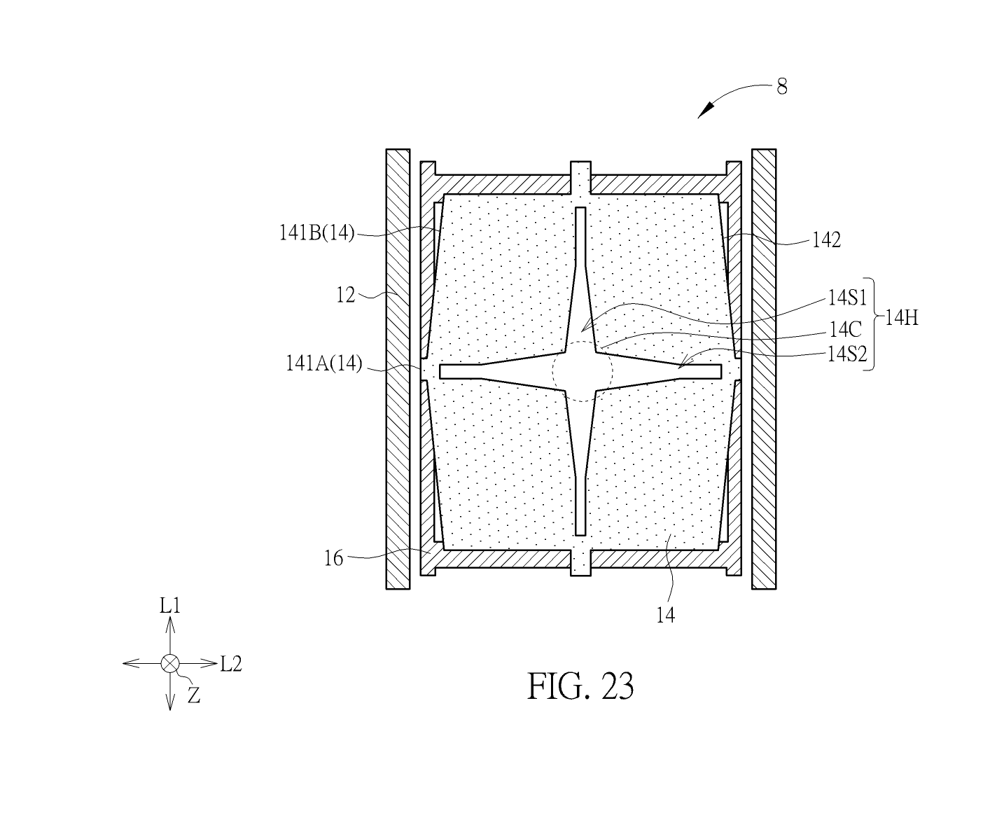

Referring to FIG. 23, FIG. 23 is a schematic diagram of the top view of the liquid crystal display panel according to the eighth embodiment of the present invention, wherein to simplify the illustration, FIG. 23 does not show some devices such as the active switch device and the gate line. As shown in FIG. 23, according to the liquid crystal display panel 8 of this embodiment, a width of the first slit 14S1 of the pixel electrode 14 in the second direction L2 has two or more different values at different positions along the first direction L1 and/or a width of the second slit 14S2 of the pixel electrode 14 in the first direction L1 has two or more different values at different positions along the second direction L2. For example, the width of the first slit 14S1 in the second direction L2 is gradually decreased outwardly from an intersection center of the cruciform opening 14H, and the width of the second slit 14S2 in the first direction L1 is gradually decreased outwardly from the intersection center of the cruciform opening 14H.

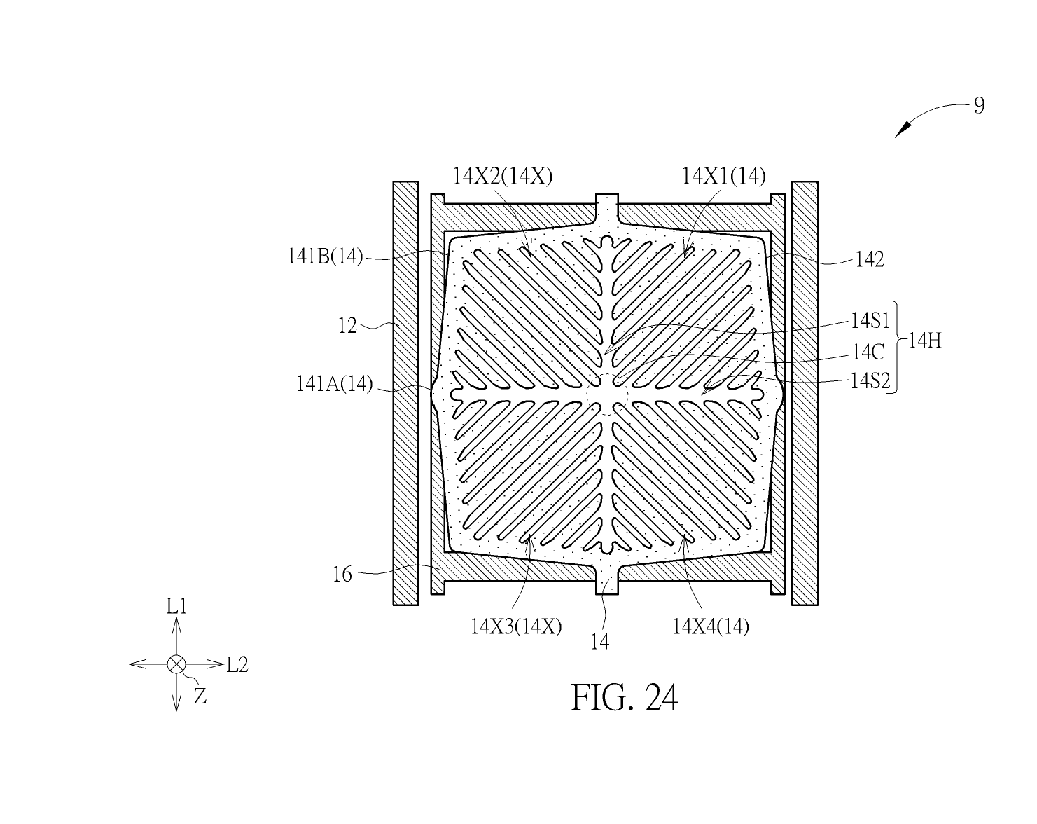

Referring to FIG. 24, FIG. 24 is a schematic diagram of the top view of the liquid crystal display panel according to the ninth embodiment of the present invention, wherein to simplify the illustration, FIG. 24 does not show some devices such as the active switch device and the gate line. As shown in FIG. 24, according to the liquid crystal display panel 9 of this embodiment, the pixel electrode 14 further includes a plurality of branch slits 14X connected to the first slit 14S1 and/or the second slit 14S2 of cruciform opening 14H. For example, the branch slits 14X may include a first branch slit 14X1, a second branch slit 14X2, a third branch slit 14X3 and a fourth branch slit 14X4 extending outwards along different direction respectively, and the first branch slit 14X1, the second branch slit 14X2, the third branch slit 14X3 and the fourth branch slit 14X4 may be perpendicular to each other. For example, a counterclockwise direction is defined as a positive angle and the second direction L2 is defined as a reference. Angles between the second direction L2 and the first branch slit 14X1, between the second direction L2 and the second branch slit 14X2, between the second direction L2 and the third branch slit 14X3, and between the second direction L2 and the fourth branch slit 14X4 may be respectively such as 45 degrees, 135 degrees, 225 degrees, and 315 degrees, but not limited thereto. According to a variant embodiment of this embodiment, angles between the second direction L2 and the first branch slit 14X1, between the second direction L2 and the second branch slit 14X2, between the second direction L2 and the third branch slit 14X3, and between the second direction L2 and the fourth branch slit 14X4 may be respectively such as 135 degrees, 45 degrees, 315 degrees, and 225 degrees, but not limited thereto.

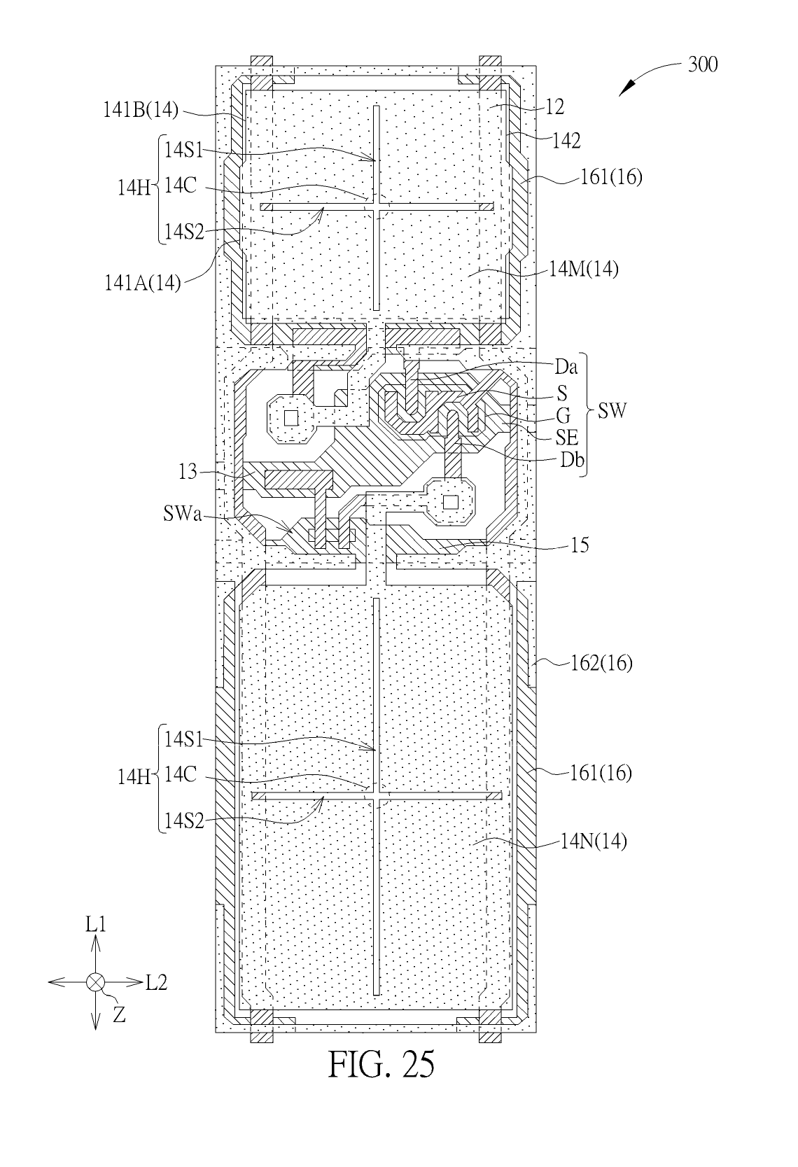

Referring to FIG. 25, FIG. 25 is a schematic diagram of the top view of the liquid crystal display panel according to the tenth embodiment of the present invention. As shown in FIG. 25, it is different to the above embodiments which the conductive line 12 is disposed outside the first electrode 16. According to the liquid crystal display panel 300 of this embodiment, the first electrode 16 is disposed outside the conductive line 12, and the conductive line 12 and the pixel electrode 14 overlap partially in a vertical projection direction Z. According to this embodiment, the pixel electrode 14 may include a main pixel electrode 14M and a sub pixel electrode 14N which are respectively electrically connected to the active switch device SW. For example, the main pixel electrode 14M and the first drain Da of the active switch device SW may be electrically connected to each other, and the sub pixel electrode 14N and the second drain Db of the active switch device SW may be electrically connected to each other. In addition, the liquid crystal display panel 300 may further include a charge sharing line 15 and another active switch device SWa, wherein the gate, source and drain of the active switch device SWa is electrically connected to the charge sharing line 15, the conductive line (gate line) 13, and the second drain Db of the active switch device SW respectively. Accordingly, the charge-sharing may be applied to the sub pixel electrode 14N when displaying, thus the problem of color wash-out can be solved. At least one of the main pixel electrode 14M and the sub pixel electrode 14N has the two first parts 141S and the second part 141B. For example, according to this embodiment, the main pixel electrode 14M has the two first parts 141A the second part 141B, wherein the two first parts 141A are respectively disposed adjacent to two opposite sides of the second slit 14S2 in the second direction L2, a distance between the two first parts 141A in the second direction L2 has a first width, the second part 141B has a second width in the second direction L2, and the first width is greater than the second width. The sub pixel electrode 14N does not have the design of the first part and the second part, that is to say, the sub pixel electrode 14N may have a design which the widths are equal in the second direction L2, but not limited thereto. According to a variant embodiment of this embodiment, both the main pixel electrode 14M and the sub pixel electrode 14N may have the two first parts 141A and the second part 141B, or the sub pixel electrode 14N may have the two first parts 141A and the second part 141B but the main pixel electrode 14M may not have the two first parts and the second part.

According to this embodiment, the first electrode 16 may include a first patterned conductive layer 161 and a second patterned conductive layer 162 which are stacked on each other and electrically connected to each other. For example, the first patterned conductive layer 161, the conductive line 13 (gate line) and the gate G may belong to a same patterned conductive layer, and the second patterned conductive layer 162 and the pixel electrode 14 may belong to a same patterned conductive layer, but not limited thereto. According to the variant embodiment of this embodiment, the first electrode 16 may be a single patterned conductive layer also, and the first electrode 16 may belong to a same patterned conductive layer with the conductive line 13, a same patterned conductive layer with the pixel electrode 14 or other patterned conductive layers.

The liquid crystal display panel of the present invention is not limited in the above embodiments, and the liquid crystal display panel described in the above embodiments can be chosen, combined and utilized as required.

In conclusion, the liquid crystal display panel of the present invention utilizes the design of the cruciform opening structure of the pixel electrode for changing the variation of the equipotential lines corresponding to the cruciform opening, so as to decrease the boundary area of the alignment areas which are situated at the two opposite sides of the cruciform opening. And, the design of the first electrode located surrounding and adjacent to the pixel electrode and the protrudent part of the pixel electrode can change the variation of the equipotential lines corresponding to the peripheral of the pixel electrode. Thus, the liquid crystal molecules LC located at the peripheral part of the first electrode can continuously lie down outwards, such that the problem of the dark lines can be improved and the transmittance can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display panel comprising:
a first substrate;
a conductive line disposed on the first substrate and extending along a first direction;
an active switch device disposed on the first substrate and electrically connected to the conductive line;
a pixel electrode disposed on the first substrate and electrically connected to the active switch device, wherein the pixel electrode has a cruciform opening which comprises a first slit extending along the first direction and a second slit extending along a second direction and intersecting the first slit;
a first electrode disposed on the first substrate and located adjacent to a periphery of the pixel electrode;
a second substrate disposed opposite to the first substrate;
a plurality of liquid crystal molecules disposed between the first substrate and the second substrate; and
a second electrode disposed on the second substrate,
wherein the pixel electrode comprises two first parts and a second part, where the two first parts are disposed adjacent to two opposite ends of the second slit in the second direction respectively, a distance between the two first parts in the second direction has a first width, the second part has a second width in the second direction, and the first width is greater than the second width.

2. The liquid crystal display panel of claim 1, wherein the conductive line is disposed on an outer side of the pixel electrode and not overlapping with the pixel electrode in a vertical projection direction.

3. The liquid crystal display panel of claim 2, wherein the two first parts protrude from the second part along the second direction, a minimum of distance between the first part and a center of the conductive line is a first distance, a minimum of distance between the second part and the center of the conductive line is a second distance, and the first distance is less than the second distance.

4. The liquid crystal display panel of claim 3, wherein a difference between the first distance and the second distance is greater than 2 micrometers (μm) and less than or equal to 10 micrometers (μm).

5. The liquid crystal display panel of claim 1, further comprising two polymer-stabilized alignment layers disposed on the first substrate and the second substrate respectively.

6. The liquid crystal display panel of claim 1, wherein the first direction and the second direction is substantially perpendicular to each other.

7. The liquid crystal display panel of claim 1, wherein the conductive line comprises a data line.

8. The liquid crystal display panel of claim 1, wherein the first electrode is disposed between the first substrate and the pixel electrode, and the first electrode and the pixel electrode overlap partially in a vertical projection direction.

9. The liquid crystal display panel of claim 1, wherein the first electrode and the pixel electrode belong to a same patterned conductive layer, and the first electrode and the conductive line overlap in a vertical projection direction.

10. The liquid crystal display panel of claim 1, further comprising a third electrode disposed on the first substrate and located adjacent to the periphery of the pixel electrode, wherein the first electrode and the third electrode respectively belong to different patterned conductive layers.

11. The liquid crystal display panel of claim 10, wherein the third electrode and the pixel electrode belong to same patterned conductive layer, and the third electrode and the conductive line overlap in a vertical projection direction.

12. The liquid crystal display panel of claim 10, wherein the first electrode and the third electrode are not electrically connected to each other.

13. The liquid crystal display panel of claim 10, wherein the first electrode and the third electrode are electrically connected to each other and cooperatively surrounding the pixel electrode completely or partially.

14. The liquid crystal display panel of claim 1, wherein a width of the first slit in the second direction and a width of the second slit in the first direction are substantially between 1 micrometer (μm) and 8 micrometers (μm).

15. The liquid crystal display panel of claim 1, wherein a ratio of a length of the first slit in the first direction and a length of the pixel electrode in the first direction is substantially greater than or equal to 0.5 and less than 1, and a ratio of a length of the second slit in the second direction and a length of the pixel electrode in the second direction is substantially greater than or equal to 0.5 and less than 1.

16. The liquid crystal display panel of claim 1, wherein the second width of the second part of the pixel electrode is decreasing gradually along the first direction from the first part.

17. The liquid crystal display panel of claim 16, wherein a side edge of the pixel electrode extends along a third direction, an angle between the third direction and the first direction is substantially greater than 0 degrees and less than or equal to 45 degrees.

18. The liquid crystal display panel of claim 1, wherein the first electrode is an enclosing figure and surrounds the pixel electrode completely.

19. The liquid crystal display panel of claim 1, wherein the first electrode is a figure having at least one breach and partially surrounds the pixel electrode.

20. The liquid crystal display panel of claim 1, wherein a width of the first slit in the second direction is not equal to a width of the second slit in the first direction.

21. The liquid crystal display panel of claim 1, wherein a width of the first slit in the second direction has two or more different values at different positions along the first direction and/or a width of the second slit in the first direction has two or more different values at different positions along the second direction.

22. The liquid crystal display panel of claim 21, wherein the width of the first slit in the second direction is gradually decreasing outwardly from an intersection center of the cruciform opening, and the width of the second slit in the first direction is gradually decreasing outwardly from the intersection center of the cruciform opening.

23. The liquid crystal display panel of claim 1, wherein the pixel electrode further comprises a plurality of branch slits connected to the first slit and/or the second slit of the cruciform opening.

24. The liquid crystal display panel of claim 1, wherein a width of the first electrode in the second direction is not equal to a width of the first electrode in the first direction.

25. The liquid crystal display panel of claim 1, wherein the conductive line and the pixel electrode overlap partially in a vertical projection direction.

26. The liquid crystal display panel of claim 25, wherein the pixel electrode comprises a main pixel electrode and a sub pixel electrode which are electrically connected to the active switch device respectively, and at least one of the main pixel electrode or the sub pixel electrode has the two first parts and the second part.

27. A method of liquid crystal alignment comprising:
providing the liquid crystal display panel of claim 1, wherein the liquid crystal molecules are mixed with a plurality of photo-curing monomers;
providing the first electrode with a first voltage, providing the second electrode with a second voltage, and providing the pixel electrode with a third voltage via the active switch device, so as to generate a pretilt angle of the liquid crystal molecules; and
in the condition of providing the first voltage, the second voltage and third voltage, utilizing light for exposing the photo-curing monomers, so as to make the photo-curing monomers polymerize as a first polymer-stabilized alignment layer and a second polymer-stabilized alignment layer, which fix the pretilt angle of the liquid crystal molecules, on the first substrate and the second substrate respectively;
wherein a difference value according to a root-mean-square value of the first voltage and a root-mean-square value of the second voltage is greater than a difference value according to a root-mean-square value of the third voltage and the root-mean-square value of the second voltage.

28. The method of liquid crystal alignment of claim 27, wherein a difference value between the difference value according to the root-mean-square value of the first voltage and the root-mean-square value of the second voltage and the difference value according to the root-mean-square value of the third voltage and the root-mean-square value of the second voltage is greater than or equal to 1 volt (V).

29. The method of liquid crystal alignment of claim 27, wherein the second voltage is a ground voltage.

30. The method of liquid crystal alignment of claim 27, wherein the third voltage is a ground voltage.

31. The method of liquid crystal alignment of claim 27, wherein the liquid crystal display panel further comprises a third electrode disposed on the first substrate and located adjacent to the periphery of the pixel electrode, and the method of the liquid crystal alignment further comprises providing the third electrode with a fourth voltage, and in the condition of providing the first voltage, the second voltage, the third voltage and the fourth voltage, utilizing light for exposing the photo-curing monomers, so as to make the photo-curing monomers polymerize as the first polymer-stabilized alignment layer and the second polymer-stabilized alignment layer, which fix the pretilt angle of liquid crystal molecules, on the first substrate and the second substrate respectively.

32. The method of liquid crystal alignment of claim 31, wherein a difference value according to a root-mean-square value of the fourth voltage and the root-mean-square value of the second voltage is greater than the difference value according to the root-mean-square value of the third voltage and the root-mean-square value of the second voltage.

33. The method of liquid crystal alignment of claim 31, wherein a difference value according to a root-mean-square value of the fourth voltage and the root-mean-square value of the second voltage is equal to the difference value according to the root-mean-square value of the first voltage and the root-mean-square value of the second voltage.

34. The method of liquid crystal alignment of claim 32, wherein the fourth voltage is equal to the first voltage.
